(19) United States
(12) Patent Application Publication
(10) Pub. No.: US 2017/0004457 A1
(43) Pub. Date: Jan. 5, 2017

(54) METHODS AND APPARATUS FOR FACILITATING IMMIGRATION TRANSACTIONS USING AN ACCOUNTING SYSTEM FOR ALLOCATING EMPLOYMENT CREDITS

(71) Applicant: Innovative Visa Solutions, LLC, Austin, TX (US)

(72) Inventor: Omar Besim Hakim, Austin, TX (US)

(73) Assignee: Innovative Visa Solutions, LLC, Austin, TX (US)

(21) Appl. No.: 15/209,479

(22) Filed: Jul. 13, 2016

Related U.S. Application Data
(63) Continuation of application No. 13/458,999, filed on Apr. 27, 2012.
(60) Provisional application No. 61/600,790, filed on Feb. 20, 2012.
(60) Provisional application No. 61/621,564, filed on Apr. 8, 2012.
(60) Provisional application No. 61/639,521, filed on Apr. 27, 2012.

(51) Int. Cl. G06Q 10/10; G06Q 50/26

(52) U.S. Cl. CPC G06Q 10/1053; G06Q 50/265

(57) ABSTRACT

Methods, systems and apparatus for facilitating immigration transactions and investments are disclosed. Data is prepared for use in an immigration compliance report. One or more employment credits are reported as being allocated to an investment. The employment credits represent jobs created through investment in a first business entity that employs one or more employees that are simultaneously employees of the first business entity and a second business entity. The one or more employees that are simultaneously employees of the first business entity and a second business entity are identified as holding jobs created by the investment in the first business entity.

### CROSS-REFERENCE TO RELATED APPLICATIONS

The present U.S. Utility Patent Application claims priority pursuant to 35 U.S.C. §120 as a continuation of U.S. Utility application Ser. No. 13/458,999, entitled “METHODS AND APPARATUS FOR FACILITATING IMMIGRATION TRANSACTIONS USING AN ACCOUNTING SYSTEM FOR ALLOCATING EMPLOYMENT CREDITS”, filed Apr. 27, 2012, which claims priority pursuant to 35 U.S.C. §119(e) to U.S. Provisional Application No. 61/600,790 entitled “METHODS AND APPARATUS FOR EMPLOYMENT COMPLIANCE MONITORING” filed Feb. 20, 2012, U.S. Provisional Application No. 61/621,564 entitled “METHODS AND APPARATUS FOR FACILITATING IMMIGRATION TRANSACTIONS” filed Apr. 8, 2012 and U.S. Provisional Application No. 61/639,521 entitled “METHODS AND APPARATUS FOR FACILITATING IMMIGRATION TRANSACTIONS USING AN ACCOUNTING SYSTEM FOR ALLOCATING EMPLOYMENT CREDITS” filed on Apr. 27, 2012, all of which are hereby incorporated herein by reference in their entirety and made part of the present U.S. Utility Patent Application for all purposes.

### BACKGROUND

### Description of the Related Art

Certain legal requirements for immigration transactions specify the monitoring, tracking, documenting and auditing of employment of persons. Specifically, the EB-5 visa for Immigrant Investors is a United States visa created by the Immigration Act of 1990 and administered by the USCIS. As used herein, the USCIS refers to the United States Citizenship and Immigration Services, a component of the United States Department of Homeland Security (DHS) or to any subsequent successor agencies or any other organizations that can evaluate compliance with standards for granting and/or grant visa approval. USCIS performs many administrative functions formerly carried out by the legacy United States Immigration and Naturalization Service (INS), which was part of the Department of Justice. The EB-5 visa program provides a method of obtaining a permanent residence visa (a.k.a., green card) for foreign nationals who invest money in business entities operating in the United States. To obtain the visa under EB-5 rules, individuals invest $1,000,000 (or at least $500,000 in a “Targeted Employment Area”-high unemployment or rural area), creating or preserving at least 10 jobs for U.S. workers excluding the investor and their immediate family.

Investments can be made directly in a job-generating commercial enterprise (new, or existing), or into a “Regional Center”—a 3rd party-managed investment vehicle (private or public), which assumes the responsibility of creating the requisite jobs.

If the foreign national investor's petition is approved, the investor and their dependents are granted conditional permanent residence valid for two years. Within the 90 day period before the conditional permanent residence expires, the investor submits evidence documenting that the full required investment has been made and that 10 jobs have been maintained, or 10 jobs have been created or will be created within a reasonable time period.

Compliance with the reporting requirements for the EB-5 program is difficult. Existing systems do not effectively provide adequate support for documentation and reporting requirements associated with the program.

A first class of problems related to EB-5 compliance primarily afflicts the interests of investors. It is frequently difficult for potential foreign investors to identify suitable investment opportunities. Frequently, businesses have difficulty providing evidence to support the conclusion that the business can, even given the requisite $1M investment, create and sustain the required ten jobs over the required 2-year period. A risk of business failure (or at least failure to grow sufficiently and sustainably) creates risk that the $1M investment will not ultimately result in issuance of a green card because the requisite jobs do not materialize or are not sustained. Further, many potential investments prove unsuitable because of an inadequate track record of profitability such that the investor is confident of adequate financial returns on the investment. Each of these problems discourages investment.

A second class of problems related to EB-5 compliance primarily afflicts the interests of the broader community. The EB-5 program is historically under-utilized. Prior to 2004, the program's peak year was 1997, in which only 1570 visas resulted from the program. From 1992-2004, a total of 6,024 visas resulted from the program (out of 130,000 possible visas). While the resulting $1 B in investment (http://www.gao.gov/new.items/d05256.pdf, page 2) has been of use to the economy of the United States, potentially up to $120 B could have been invested in the U.S. economy over that same period, which could have resulted in a hugely positive impact on American employment, if suitable investment vehicles existed.

A third class of problems related to EB-5 compliance primarily afflicts the interests of entities that could receive the potential investment. Capital for growth has been particularly scarce in the period from 2008-2012. Entities that might desire to grow through EB-5 capital have not had access to that capital because they lack the tools for accessing the capital.

### SUMMARY

Various embodiments of methods and apparatus for facilitating immigration transactions through accounting systems for allocating employment credits are disclosed.

In some embodiments, it is possible to facilitate greater investment in the economy of the United States, to enable desirable foreign investors to enter the United States, and to enable companies that would otherwise be unable to attract foreign investment to receive investment capital.

In some embodiments, the ability to allocate investments is made flexible by allowing jobs created by an entity to be allocated between investments as job credits, thus allowing time-shifting of job creation and pooling of jobs and job credits or other economic metrics. Some embodiments provide the ability to the ability to aggregate jobs or job credits from multiple entities into a single providing entity through co-employment arrangements. Such embodiments enable an investor to have a guarantee of jobs or job credits in the requisite quantity, even if no single small business PEO client can provide the requisite jobs resulting from growth. In some embodiments, the PEO can provide the requisite job credits resulting from growth through allocation of credits for jobs resulting from growth in multiple PEO client entities. As used herein, the term PEO is interchangeable with the term HRO (human resources organization).

In some embodiments, data is prepared for use in an immigration requirements compliance report. In some embodiments preparing data for use in an immigration requirements compliance report includes reporting one or more employment credits as being allocated to an investment. In some embodiments, the employment credits represent jobs created through investment in a first business entity that employs one or more employees that are simultaneously employees of the first business entity and a second business entity. In some embodiments, reporting one or more employment credits as being allocated to an investment further includes reporting one or more employment credits as being allocated to an investment from a foreign investor. In some embodiments, reporting one or more employment credits as being allocated to an investment further includes reporting one or more employment credits as being allocated to an investment from a foreign investor in the first business entity without investment by the investor in the second business entity. In some embodiments, reporting one or more employment credits as being allocated to an investment further comprises reporting one or more employment credits as being allocated to an investment from a foreign investor in the first business, and the second business entity is a recipient of investment by the first business entity.

In some embodiments, preparing data for use in an immigration compliance report includes identifying the one or more employees that are simultaneously employees of the first business entity and a second business entity as holding jobs created by the investment in the first business entity. In some embodiments, the investment compliance report includes information regarding investment by a non-U.S. resident seeking to comply with U.S. immigration rules regarding residency. In some embodiments, the investment compliance report is automatically prepared using a computer system. In some embodiments, a first organization or first entity or first business entity is a professional employment organization (PEO or HRO), and at least one of the employees of the first organization or first entity or first business entity is co-employed by a second organization or second entity or second business entity. In some embodiments, one or more of the employees is co-employed by the first organization or first entity or first business entity and the second organization or second entity or second business entity.

The EB-5 visa for Immigrant Investors is a United States visa created by the Immigration Act of 1990. The program is currently scheduled to end on Sep. 30, 2012, and embodiments similarly support replacement or renewal programs and similar investment-driven or employment-driven citizenship, residency or immigration schemes.

The EB-5 visa program for which some embodiments facilitate a citizenship, residency or immigration transaction provides a method of obtaining a green card for foreign nationals who invest money in the United States. To obtain the visa under EB-5 rules, individuals invest $1,000,000 (or at least $500,000 in a “Targeted Employment Area”—high unemployment or rural area), creating or preserving at least 10 jobs for U.S. workers excluding the investor and their immediate family.

Investments can be made directly in a job-generating commercial enterprise (new, or existing), or into a “Regional Center”—a 3rd party-managed investment vehicle (private or public), which assumes the responsibility of creating the requisite jobs. Some embodiments support recordkeeping and compliance auditing for all types of qualifying employment.

Methods and apparatus for facilitating immigration transactions are disclosed. In one embodiment, one or more investments in one or more entities are recorded in an accounting system. One or more economic metrics are allocated in the accounting system to the one or more investments. Execution of one or more immigration transactions is facilitated by generating one or more records for ascertaining immigration compliance of the one or more investments with respect to the one or more immigration transactions.

In some embodiments, the allocating in the accounting system the one or more economic metrics to the one or more investments further includes allocating in the accounting system one or more employment credits to the one or more investments. In some embodiments, the facilitating the execution of the one or more immigration transactions by generating one or more records for ascertaining the immigration compliance of the one or more investments with respect to the one or more immigration transactions further includes ascertaining the immigration compliance of the one or more investments based at least in part upon the economic metrics.

Additionally, methods and apparatus for employment compliance monitoring are disclosed. In one embodiment, an investment in an entity is recorded, and a plurality of employment creation credits are allocated to the investment. Some embodiments further facilitate a citizenship, residency or immigration transaction by generating audit records for verifying compliance properties of the plurality of compliance credits.

In some embodiments, the citizenship, residency or immigration transaction facilitated is an EB-5 visa transaction, or a similar investment-driven transaction for which employment is tracked. Some embodiments monitor compliance with the criteria spelled out in INA s. 203(b)(5) and 8 CFR s. 204.6.

Some embodiments support monitoring and compliance reports for transactions created so as to facilitate approval of a visa, such that, if the foreign national investor's petition is approved, the investor and their dependents will be granted conditional permanent residence valid for two years. In some embodiments, reports support filings required to, within the 90 day period before the conditional permanent residence expires, allow the investor to submit evidence documenting that the full required investment has been made and that 10 jobs have been maintained, or 10 jobs have been created or will be created within a reasonable time period.

Some embodiments further support transactions under the Startup Visa Act (projected EB-6 visa), introduced in Congress in 2010 and subsequently in 2011, which is planned to use unallocated numbers from the EB-5 visa. A person having ordinary skill in the art will readily comprehend, in light of having read the present disclosure, that the embodiments described herein with respect to the EB-5/EB-6 visa programs are non-limiting examples, and that other employment compliance transactions, both within and outside of the immigration, residency, and citizenship space, fall within the scope of the described embodiments.

Some embodiments support compliance with the requirements of the EB-5/EB-6 visa programs through co-employment. In co-employment, an investment in a PEO, or professional employer organization, which, in some embodiments is a company that provides HR-related services to clients through a business arrangement known as co-employment, is used to facilitate the immigration transaction. Investment in the PEO is used to create jobs. Job creation credits are allocated to the investment. Some embodiments track allocation of the job creation credits to jobs in the PEO.

Under this arrangement as supported by some embodiments, the PEO assumes or shares many of the responsibilities of being an employer. Co-employment is the contractual arrangement between the client and the PEO that allows the PEO to provide a full range of services and to transfer or share many employer's liabilities, including EB-5/EB-6 compliance. Workers become employees of two employers; the client retains supervision for production or delivery of service, and the PEO assumes responsibility for human resources and personnel services, including EB-5/EB-6 compliance. A client of the PEO controls execution of work tasks by the workers while the PEO supplements the details of employment and compliance with an EB-5 visa program or other employment compliance programs executed using embodiments. One of skill in the art will readily comprehend, in light of having read the present description, that, as used herein, the terms job credit and employment credit are interchangeable.

Some embodiments provide a method, system, and/or computer program product for aggregating and allocating job credits used for immigration regulatory compliance. In some embodiments, investments are allowed to be provided from two or more qualified immigrants to a first entity. The first entity hires two or more employees who then provide services to a second entity, and the services are provided in exchange for consideration being provided by the second entity to the first entity. Job credits for immigration regulatory compliance are aggregated in an electronic accounting system to the first entity, based on the employment of the two or more employees. At least two of the job credits are allocated in the electronic accounting system to two or more of the qualified immigrants, for the purposes of immigration regulatory compliance of two or more of the qualified immigrants.

In some embodiments, the allocating is performed automatically by the electronic accounting system, after receipt of job credits into the accounting system. Some embodiments further include automatically allocating job credits in the accounting system based on the length of time available to an immigrant to comply with an immigration regulatory requirement. In some embodiments job credits are automatically allocated in the accounting system based on the length of time available to an immigrant to comply with an immigration regulatory requirement, with allocations being first made to immigrants that have the least amount of time available to comply with an immigration regulatory requirement.

In some embodiments, the aggregating is performed automatically by the electronic accounting system, after receipt of job credits into the accounting system. In some embodiments, at least some of the job credits are aggregated for immigration regulatory compliance to the first entity from a third entity. Services are provided to the third entity in exchange for consideration being paid by the third entity to the first entity. In some embodiments, at least some of the job credits are aggregated for immigration regulatory compliance to the first entity from a third entity. Services are provided to the third entity in exchange for consideration being paid by the third entity to the first entity, and job credits from the second entity and job credits from the third entity are provided to an immigrant.

Some embodiments automatically track in the accounting system allocated job credits to two or more qualified immigrants, from a second entity and a third entity, over a period of time. Some embodiments automatically receive data regarding the two or employees into the accounting system. In some embodiments, the accounting system is used to prepare an immigration regulatory compliance report. Some embodiments further perform automatically ensuring that job credits for any employee are only applied as a job credit for one immigrant.

Some embodiments provide a method, system, and/or computer program product for automatically creating at least a portion of an immigration regulatory compliance report. Investments are allowed to be provided from two or more qualified immigrants to a first entity. The first entity hires two or more employees who then provide services to a second entity. The services are provided in exchange for consideration being paid by the second entity to the first entity. Job credits for immigration regulatory compliance are received in an electronic accounting system to the first entity, based on the employment of the two or more employees. Two or more of the job credits are applied in the electronic accounting system to two or more of the qualified immigrants, for the purposes of immigration regulatory compliance of two or more of the qualified immigrants. The applied job credits are used to automatically create at least a portion of an immigration regulatory compliance report.

In some embodiments information pertaining to an immigration regulatory compliance report is automatically provided to a regulatory agency. In some embodiments, the applying is performed automatically by the electronic accounting system, after receipt of job credits into the accounting system. Some embodiments automatically ensure that job credits for any employee are only applied as a job credit for one immigrant. In some embodiments, one or more of the employees is co-employed by the first entity and the second entity. Some embodiments allow investments to be provided from two or more qualified immigrants to the first entity without allowing investments to be provided from two or more qualified immigrants to the second entity.

Some embodiments provide a method, system, and/or computer program product for aggregating and allocating job credits used for immigration regulatory compliance. Investments are allowed to be provided from two or more qualified immigrants to a first entity. The first entity hires two or more employees who then provide services to a second entity, and the services are provided in exchange for consideration being paid by the second entity to the first entity. Job credits for immigration regulatory compliance are aggregated in a processor system to the first entity, based on the employment of the two or more employees. At least two of the job credits are allocated in the processor system to two or more of the qualified immigrants, for the purposes of immigration regulatory compliance of two or more of the qualified immigrants.

Some embodiments automatically provide information pertaining to an immigration regulatory compliance report to a regulatory agency. In some embodiments, aggregating is performed automatically by the processor system, after a receipt of job credits into the processor system. Some embodiments automatically ensure that job credits for any employee are only applied as a job credit for one immigrant. In some embodiments, one or more of the employees is co-employed by the first entity and the second entity.

### BRIEF DESCRIPTION OF THE DRAWINGS

FIG. 1 depicts a network-deployed system for facilitating immigration transactions using an accounting system for allocating employment credits, according to some embodiments.

FIG. 2 illustrates a module that may implement facilitating immigration transactions using an accounting system for allocating employment credits, according to some embodiments.

FIG. 3A is a high-level logical flowchart of a set of operations used in facilitating immigration transactions using an accounting system for allocating employment credits, according to some embodiments.

FIG. 3B is a high-level logical flowchart of a set of operations used in facilitating immigration transactions using an accounting system for allocating employment credits, according to some embodiments.

FIG. 4 is a high-level logical flowchart of operations used in facilitating immigration transactions using an accounting system for allocating employment credits, according to some embodiments.

FIG. 5 is a high-level logical flowchart of operations used in employment compliance monitoring to facilitate a citizenship, residency or immigration transaction, according to some embodiments.

FIG. 6 is a high-level logical flowchart of operations used in employment compliance monitoring to facilitate a citizenship, residency or immigration transaction, according to some embodiments.

FIG. 7A illustrates a business model that may be implemented using a system for facilitating immigration transactions using an accounting system for allocating employment credits, according to some embodiments.

FIG. 7B is a flowchart of operations that can be performed in execution of a business model that may be implemented using a system for facilitating immigration transactions using an accounting system for allocating employment credits, according to some embodiments.

FIG. 8A depicts a business model that may be implemented using a system for facilitating immigration transactions using an accounting system for allocating employment credits, according to some embodiments.

FIG. 8B is a flowchart of operations that can be performed in execution of a business model that may be implemented using a system for facilitating immigration transactions using an accounting system for allocating employment credits, according to some embodiments.

FIG. 9A illustrates a business model that may be implemented using a system for facilitating immigration transactions using an accounting system for allocating employment credits, according to some embodiments.

FIG. 9B is a flowchart of operations that can be performed in execution of a business model that may be implemented using a system for facilitating immigration transactions using an accounting system for allocating employment credits, according to some embodiments.

FIG. 10A illustrates a business model that may be implemented using a system for facilitating immigration transactions using an accounting system for allocating employment credits, according to some embodiments.

FIG. 10B is a flowchart of operations that can be performed in execution of a business model that may be implemented using a system for facilitating immigration transactions using an accounting system for allocating employment credits, according to some embodiments.

FIG. 11A illustrates a business model that may be implemented using a system for facilitating immigration transactions using an accounting system for allocating employment credits, according to some embodiments.

FIG. 11B is a flowchart of operations that can be performed in execution of a business model that may be implemented using a system for facilitating immigration transactions using an accounting system for allocating employment credits, according to some embodiments.

FIG. 12A illustrates a business model that may be implemented using a system for facilitating immigration transactions using an accounting system for allocating employment credits, according to some embodiments.

FIG. 12B is a flowchart of operations that can be performed in execution of a business model that may be implemented using a system for facilitating immigration transactions using an accounting system for allocating employment credits, according to some embodiments.

FIG. 13A illustrates a business model that may be implemented using a system for facilitating immigration transactions using an accounting system for allocating employment credits, according to some embodiments.

FIG. 13B is a flowchart of operations that can be performed in execution of a business model that may be implemented using a system for facilitating immigration transactions using an accounting system for allocating employment credits, according to some embodiments.

FIG. 14A illustrates a business model that may be implemented using a system for facilitating immigration transactions using an accounting system for allocating employment credits, according to some embodiments.

FIG. 14B illustrates a business model that may be implemented in some embodiments.

FIG. 14C illustrates a business model that may be implemented in some embodiments.

FIG. 14D illustrates a business model that may be implemented in some embodiments.

FIG. 14E illustrates a business model that may be implemented in some embodiments.

FIG. 15A is a flowchart of operations that can be performed in execution of a business model that may be implemented using a system for facilitating immigration transactions using an accounting system for allocating employment credits, according to some embodiments.

FIG. 15B is a flowchart of operations that can be performed in aggregating and allocating job credits used for immigration regulatory compliance, according to some embodiments.

FIG. 15C is a flowchart of operations that can be performed in automatically creating at least a portion of an immigration regulatory compliance report, according to some embodiments.

FIG. 15D is a flowchart of operations that can be performed in aggregating and allocating job credits used for immigration regulatory compliance, according to some embodiments.

FIG. 15E is a flowchart of operations that can be performed in automatically creating at least a portion of an immigration regulatory compliance report, according to some embodiments.

FIG. 15F is a flowchart of operations that can be performed in aggregating and allocating job credits used for immigration regulatory compliance, according to some embodiments.

FIG. 15G is a flowchart of operations that can be performed in execution of a business model that may be implemented using a system for employment compliance monitoring, according to some embodiments.

FIG. 16 illustrates an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to. Additionally, while particular modules are described herein as performing particular functions, one of skill in the art will readily ascertain in light of having read the present disclosure that functions described may be combined into more, fewer, or different modules, or functions may be omitted, added or substituted from modules without departing from the scope and intent of the present disclosure. One of skill in the art will realize that modules and operations presented with respect to some embodiments may be substituted into other embodiments without departing from the scope and intent of the present disclosure. One of skill in the art will further realize that while particular items or attributes are described with respect to particular embodiments in the singular or plural, substitution of singular for plural or plural for singular may at times prove advantageous for configuring embodiments without departing from the scope and intent of this disclosure.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art.

An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### Introduction to Facilitating Immigration Transactions

Various embodiments of methods and apparatus for facilitating immigration transactions are disclosed. In some embodiments, data is prepared for use in an immigration compliance report. In some embodiments preparing data for use in an immigration compliance report includes reporting one or more employment credits as being allocated to an investment. In some embodiments, the employment credits represent jobs created through investment in a first business entity that employs one or more employees that are simultaneously employees of the first business entity and a second business entity. In some embodiments, reporting one or more employment credits as being allocated to an investment further includes reporting one or more employment credits as being allocated to an investment from a foreign investor. In some embodiments, reporting one or more employment credits as being allocated to an investment further includes reporting one or more employment credits as being allocated to an investment from a foreign investor in the first business entity without investment by the investor in the second business entity. In some embodiments, reporting one or more employment credits as being allocated to an investment further includes reporting one or more employment credits as being allocated to an investment from a foreign investor in the first business, and the second business entity is a recipient of investment by the first business entity.

In some embodiments, preparing data for use in an immigration compliance report includes identifying the one or more employees that are simultaneously employees of the first business entity and a second business entity as holding jobs created by the investment in the first business entity. In some embodiments, the investment compliance report includes information regarding investment by a non-U.S. resident seeking to comply with U.S. immigration rules regarding residency. In some embodiments, the investment compliance report is automatically prepared using a computer system. In some embodiments, the first organization is a professional employment organization, and at least one of the employees of the first organization is co-employed by the second organization. In some embodiments, one or more of the employees is co-employed by the first organization and the second organization.

In one embodiment, one or more investments in one or more entities are recorded in an accounting system. One or more economic metrics are allocated in the accounting system to the one or more investments. Execution of one or more immigration transactions is facilitated by generating one or more records for ascertaining immigration compliance of the one or more investments with respect to the one or more immigration transactions.

In some embodiments, the allocating in the accounting system the one or more economic metrics to the one or more investments further includes allocating in the accounting system one or more employment credits to the one or more investments through a co-employment arrangement, and the facilitating execution of the one or more immigration transactions by the generating one or more records for ascertaining immigration compliance of the one or more investments with respect to the one or more immigration transactions further includes allocating jobs created through the co-employment arrangement to an investor in a professional employment organization.

In some embodiments, the facilitating the execution of the one or more immigration transactions by generating one or more records for ascertaining the immigration compliance of the one or more investments with respect to the one or more immigration transactions further includes ascertaining the immigration compliance of the one or more investments based at least in part upon the economic metrics.

In some embodiments, the facilitating the execution of the one or more immigration transactions by generating one or more records for ascertaining the immigration compliance of the one or more investments with respect to the one or more immigration transactions further includes generating one or more reports complying with immigration authority regulations.

In some embodiments, the facilitating the execution of the one or more immigration transactions by generating one or more records for ascertaining the immigration compliance of the one or more investments with respect to the one or more immigration transactions further includes generating one or more reports documenting compliance with immigration authority regulations.

In some embodiments, the facilitating the execution of the one or more immigration transactions by generating one or more records for ascertaining the immigration compliance of the one or more investments with respect to the one or more immigration transactions further includes generating an accounting report for documenting compliance with taxation regulations.

In some embodiments, the facilitating the execution of the one or more immigration transactions by generating one or more records for ascertaining the immigration compliance of the one or more investments with respect to the one or more immigration transactions further includes generating one or more records for verifying persistence of jobs associated with the one or more investments in the one or more entities.

Some embodiments further include calculating a contractually agreed return on the one or more investments. Some embodiments further include calculating one or more contractually agreed returns on the one or more investments, and generating one or more records for reporting the one or more contractually agreed returns on the one or more investments.

In some embodiments, the allocating in the accounting system the one or more economic metrics to the one or more investments further includes identifying a plurality of new jobs created with the one or more investments and generating documentation of the new jobs created with the one or more investments.

Various embodiments of methods and apparatus for employment compliance monitoring are disclosed. In one embodiment, an investment in an entity is recorded, and a plurality of employment creation credits are allocated to the investment. Some embodiments perform and/or support monitoring one or more compliance properties of the plurality of employment creation credits. In some embodiments, the recording the investment in the entity further includes calculating a contractually agreed return on the investment. In some embodiments, the allocating the plurality of employment creation credits to the investment further includes identifying a plurality of new jobs created with the investment, and generating documentation of the new jobs created with the investment.

Some embodiments further perform and/or support facilitating a citizenship, residency or immigration transaction by generating audit records for verifying compliance properties of the plurality of compliance credits. Some embodiments further perform and/or support facilitating accounting records for tax preference transactions related to employment goals facilitated by investments.

In some embodiments, the facilitating the citizenship, residency or immigration transaction by generating the audit records for verifying the compliance properties of the plurality of compliance credits further includes generating records for verifying persistence of jobs associated with the investment in the entity. In some embodiments, the facilitating the citizenship, residency or immigration transaction by generating the audit records for verifying the compliance properties of the plurality of compliance credits further includes generating records for verifying persistence of jobs associated with the investment in the entity.

Some embodiments may include a system for facilitating immigration transactions. For example, a human resource allocation module may include program instructions executable by at least one processor to perform recording one or more investments in one or more entities are recorded in an accounting system, allocating one or more economic metrics in the accounting system to the one or more investments, and facilitating execution of one or more immigration transactions by generating one or more records for ascertaining immigration compliance of the one or more investments with respect to the one or more immigration transactions.

In some embodiments, the program instructions executable by at least one processor to perform the allocating in the accounting system the one or more economic metrics to the one or more investments further include program instructions executable by at least one processor to perform allocating in the accounting system one or more employment credits to the one or more investments (by way of non-limiting example, through a co-employment arrangement), and, in some such embodiments, the program instructions executable by at least one processor to perform facilitating execution of the one or more immigration transactions by the generating one or more records for ascertaining immigration compliance of the one or more investments with respect to the one or more immigration transactions further include program instructions executable by at least one processor to perform allocating jobs created through the co-employment arrangement to an investor in a professional employment organization.

In some embodiments, the program instructions executable by at least one processor to perform facilitating the execution of the one or more immigration transactions by generating one or more records for ascertaining the immigration compliance of the one or more investments with respect to the one or more immigration transactions further include program instructions executable by at least one processor to perform ascertaining the immigration compliance of the one or more investments based at least in part upon the economic metrics.

In some embodiments, the program instructions executable by at least one processor to perform facilitating the execution of the one or more immigration transactions by generating one or more records for ascertaining the immigration compliance of the one or more investments with respect to the one or more immigration transactions further include program instructions executable by at least one processor to perform generating one or more reports complying with immigration authority regulations.

In some embodiments, the program instructions executable by at least one processor to perform facilitating the execution of the one or more immigration transactions by generating one or more records for ascertaining the immigration compliance of the one or more investments with respect to the one or more immigration transactions further include program instructions executable by at least one processor to perform generating one or more reports documenting compliance with immigration authority regulations.

In some embodiments, the program instructions executable by at least one processor to perform the facilitating the execution of the one or more immigration transactions by generating one or more records for ascertaining the immigration compliance of the one or more investments with respect to the one or more immigration transactions further include program instructions executable by at least one processor to perform generating an accounting report for documenting compliance with taxation regulations.

In some embodiments, the program instructions executable by at least one processor to perform facilitating the execution of the one or more immigration transactions by generating one or more records for ascertaining the immigration compliance of the one or more investments with respect to the one or more immigration transactions further include program instructions executable by at least one processor to perform generating one or more records for verifying persistence of jobs associated with the one or more investments in the one or more entities.

Some embodiments further include program instructions executable by at least one processor to perform calculating a contractually agreed return on the one or more investments. Some embodiments further include program instructions executable by at least one processor to perform calculating one or more contractually agreed returns on the one or more investments, and program instructions executable by at least one processor to perform generating one or more records for reporting the one or more contractually agreed returns on the one or more investments.

In some embodiments, the program instructions executable by at least one processor to perform allocating in the accounting system the one or more economic metrics to the one or more investments further include program instructions executable by at least one processor to perform identifying a plurality of new jobs created with the one or more investments and generating documentation of the new jobs created with the one or more investments.

Various embodiments of methods and apparatus for employment compliance monitoring are disclosed. In one embodiment, an investment in an entity is recorded, and a plurality of employment creation credits are allocated to the investment. Some embodiments perform and/or support monitoring one or more compliance properties of the plurality of employment creation credits. In some embodiments, the recording the investment in the entity further includes calculating a contractually agreed return on the investment. In some embodiments, the allocating the plurality of employment creation credits to the investment further includes identifying a plurality of new jobs created with the investment, and generating documentation of the new jobs created with the investment.

Some embodiments further perform and/or support facilitating a citizenship, residency or immigration transaction by generating audit records for verifying compliance properties of the plurality of compliance credits. Some embodiments further perform and/or support facilitating accounting records for tax preference transactions related to employment goals facilitated by investments.

In some embodiments, the facilitating the citizenship, residency or immigration transaction by generating the audit records for verifying the compliance properties of the plurality of compliance credits further includes generating records for verifying persistence of jobs associated with the investment in the entity. In some embodiments, the facilitating the citizenship, residency or immigration transaction by generating the audit records for verifying the compliance properties of the plurality of employment creation credits further includes generating records for verifying persistence of jobs associated with the investment in the entity.

Some embodiments may include a means for performing employment compliance monitoring. For example, a human resource allocation module may include means for performing recording an investment in an entity and allocating a plurality of employment creation credits to the investment, as described herein. Some embodiments further provide a means for performing and/or support monitoring one or more compliance properties of the plurality of employment creation credits. In some embodiments, the means for recording the investment in the entity further includes a means for calculating a contractually agreed return on the investment. In some embodiments, the means for allocating the plurality of employment creation credits to the investment further includes means for identifying a plurality of new jobs created with the investment, and generating documentation of the new jobs created with the investment.

Some embodiments include a method for aggregating and allocating job credits used for immigration regulatory compliance. In some embodiments, the method includes allowing investments to be provided from two or more qualified immigrants to a first entity, wherein the first entity hires two or more employees who then provide services to a second entity, and the services are provided in exchange for consideration being provided by the second entity to the first entity. In some embodiments, the method further includes aggregating in an electronic accounting system job credits for immigration regulatory compliance to the first entity, based on the employment of the two or more employees, and allocating in the electronic accounting system at least two of the job credits to two or more of the qualified immigrants, for the purposes of immigration regulatory compliance of two or more of the qualified immigrants.

In some embodiments, the allocating is performed automatically by the electronic accounting system, after receipt of job credits into the accounting system. In some embodiments, the method further includes automatically allocating job credits in the accounting system based on the length of time available to an immigrant to comply with an immigration regulatory requirement. In some embodiments, the method further includes automatically allocating job credits in the accounting system based on the length of time available to an immigrant to comply with an immigration regulatory requirement, with allocations being first made to immigrants that have the least amount of time available to comply with an immigration regulatory requirement. In some embodiments the aggregating is performed automatically by the electronic accounting system, after receipt of job credits into the accounting system. In some embodiments, at least some of the job credits are aggregated for immigration regulatory compliance to the first entity from a third entity, wherein services are provided to the third entity in exchange for consideration being paid by the third entity to the first entity.

In some embodiments, at least some of the job credits are aggregated for immigration regulatory compliance to the first entity from a third entity, wherein services are provided to the third entity in exchange for consideration being paid by the third entity to the first entity, and wherein job credits from the second entity and job credits from the third entity are provided to an immigrant. In some embodiments, the method further comprises automatically tracking in the accounting system allocated job credits to two or more qualified immigrants, from a second entity and a third entity, over a period of time. In some embodiments, the method further includes automatically receiving data regarding the two or employees into the accounting system. In some embodiments, the method further includes using the accounting system to prepare an immigration regulatory compliance report. In some embodiments, the method further includes automatically ensuring that job credits for any employee are only applied as a job credit for one immigrant.

Some embodiments include a method for automatically creating at least a portion of an immigration regulatory compliance report. In some embodiments, the method includes allowing investments to be provided from two or more qualified immigrants to a first entity, wherein the first entity hires two or more employees who then provide services to a second entity, and the services are provided in exchange for consideration being paid by the second entity to the first entity. In some embodiments, the method further includes receiving in an electronic accounting system job credits for immigration regulatory compliance to the first entity, based on the employment of the two or more employees. In some embodiments, the method further includes applying in the electronic accounting system two or more of the job credits to two or more of the qualified immigrants, for the purposes of immigration regulatory compliance of two or more of the qualified immigrants, and using the applied job credits to automatically create at least a portion of an immigration regulatory compliance report.

In some embodiments, the method further includes automatically providing information pertaining to an immigration regulatory compliance report to a regulatory agency. In some embodiments, the applying is performed automatically by the electronic accounting system, after receipt of job credits into the accounting system. In some embodiments, the method further includes automatically ensuring that job credits for any employee are only applied as a job credit for one immigrant. In some embodiments, one or more of the employees is co-employed by the first entity and the second entity. In some embodiments, the allowing investments to be provided from two or more qualified immigrants to the first entity further includes allowing investments to be provided from two or more qualified immigrants to the first entity without allowing investments to be provided from two or more qualified immigrants to the second entity.

Some embodiments include a method for aggregating and allocating job credits used for immigration regulatory compliance. In some embodiments, the method includes allowing investments to be provided from two or more qualified immigrants to a first entity, wherein the first entity hires two or more employees who then provide services to a second entity, and the services are provided in exchange for consideration being paid by the second entity to the first entity. In some embodiments, the method includes aggregating in a processor system job credits for immigration regulatory compliance to the first entity, based on the employment of the two or more employees, and allocating in the processor system at least two of the job credits to two or more of the qualified immigrants, for the purposes of immigration regulatory compliance of two or more of the qualified immigrants.

In some embodiments, the method further includes automatically providing information pertaining to an immigration regulatory compliance report to a regulatory agency. In some embodiments the aggregating is performed automatically by the processor system, after a receipt of job credits into the processor system. In some embodiments, the method includes automatically ensuring that job credits for any employee are only applied as a job credit for one immigrant. In some embodiments, one or more of the employees is co-employed by the first entity and the second entity.

Some embodiments include a method for creating at least a portion of an immigration regulatory compliance report. In some embodiments, the method includes allowing investments to be provided from two or more qualified immigrants to a first entity, wherein the first entity hires two or more employees who then provide services to a second entity, and the services are provided in exchange for consideration being paid by the second entity to the first entity. In some embodiments, the method further includes receiving in a processor job credits for immigration regulatory compliance to the first entity, based on the employment of the two or more employees.

In some embodiments, the method further includes applying in the processor two or more of the job credits to two or more of the qualified immigrants, for the purposes of immigration regulatory compliance of two or more of the qualified immigrants, and using the applied job credits to automatically create at least a portion of an immigration regulatory compliance report.

Some embodiments include a method. In some embodiments, one or more processors are used to perform preparing data for use in an immigration compliance report. In some embodiments the preparing the data for use in the immigration compliance report includes reporting one or more employment credits as being allocated to an investment, wherein the employment credits represent jobs created through investment in a first business entity that employs one or more employees that are providing services to a second business entity, and identifying the one or more employees that are employees of the first business entity, and providing services to the second business entity, as holding jobs created by the investment in the first business entity.

The human resource allocation module or other methods and systems for facilitating immigration transactions as described herein may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to perform recording one or more investments in one or more entities are recorded in an accounting system, allocating one or more economic metrics in the accounting system to the one or more investments, and facilitating execution of one or more immigration transactions by generating one or more records for ascertaining immigration compliance of the one or more investments with respect to the one or more immigration transactions, as well as other functions described above with respect to various embodiments of methods and systems for facilitating immigration transactions.

The computer-readable storage medium may store program instructions executable by the one or more processors to cause the computing apparatus to perform recording an investment in an entity and allocating a plurality of employment creation credits to the investment, as described herein. Other embodiments of the human resource allocation module may be at least partially implemented by hardware circuitry and/or firmware stored, for example, in a non-volatile memory.

While a processor is generally understood to mean a microprocessor or other computing apparatus, some embodiments of the present invention support human processing (e.g., pen and paper recording and allocating) executing the steps described. The human resource allocation module may in some embodiments be implemented by a processor including human intervention and non-transitory media. Such a human processor may record an investment in an entity and allocating a plurality of employment creation credits to the investment, as described herein. In some embodiments, a hybrid approach, such as crowd sourcing of a distributed task using a microprocessor based supervision system and a plurality of human processors (e.g., Mechanical Turk™) may perform the operations described herein record an investment in an entity and allocating a plurality of employment creation credits to the investment. A hybrid approach or a human processor may be used to perform recording one or more investments in one or more entities are recorded in an accounting system, allocating one or more economic metrics in the accounting system to the one or more investments, and facilitating execution of one or more immigration transactions by generating one or more records for ascertaining immigration compliance of the one or more investments with respect to the one or more immigration transactions.

### Example Implementations for Facilitating Immigration Transactions

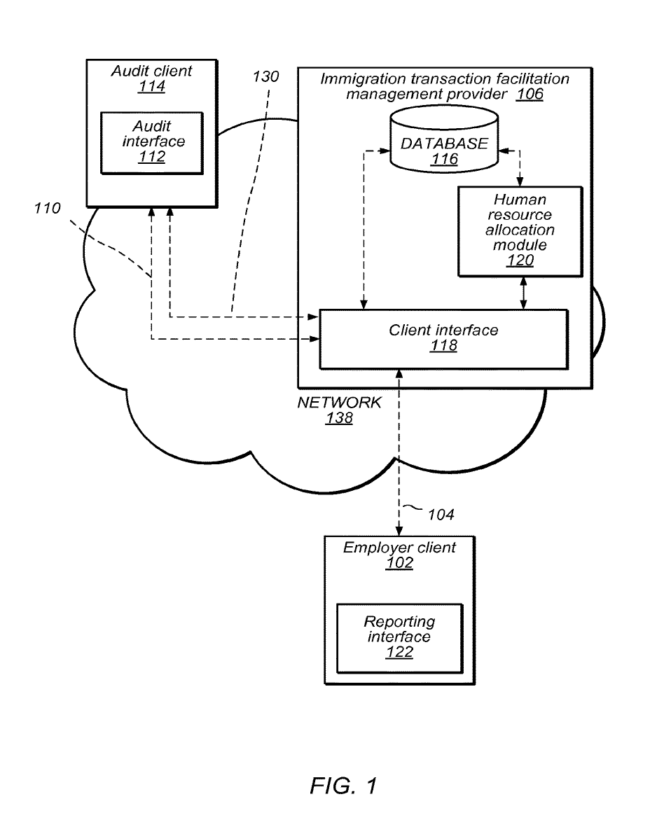

FIG. 1 depicts a network-deployed system for facilitating immigration transactions using an accounting system for allocating employment credits. An immigration transaction facilitation management provider 106 provides services related to immigration transaction facilitation and monitoring, as described herein. In some embodiments, immigration transaction facilitation management provider 106 provides a human resource allocation module 120 that interacts with an employer client 102 and an audit client 114 over a network 138 through a client interface 118, to provide services related to immigration transaction facilitation and monitoring, as described herein.

In one embodiment, immigration transaction facilitation management provider 106 executes a business method in which users of an audit client place financial investments on behalf of investors through an audit interface 112 of audit client 114 in an employer providing immigration transaction facilitation management provider 106, such as, by way of non-limiting example, a professional employment organization. Examples of such business methods and operations for executing, supporting, and monitoring such business methods are discussed below. Such investments are recorded through transaction orders 110 transmitted to client interface 118 for recording in a database 116 by a human resource allocation module 120. Upon recording, the investment is allocated by human resource allocation module 120 to jobs created using the investment to place employees with an employer, such as, by way of non-limiting example, through co-employment.

The employer sends to client interface 118 through reporting interface 122 of employer client 102 reporting information 104 with respect to jobs created using the investment to place employees with the employer. The reporting information is recorded in database 116 by human resource allocation module 120. Upon receipt of a request from audit client 114, human resource allocation module 120 queries database 116 and generates a report 130 for tracking the investment and jobs created as a result of the investment. The report 130 is sent to audit client 114.

In some embodiments, the report 130 is provided to a government agency to facilitate a citizenship, residency or immigration transaction in which a preferred citizenship, residency or immigration status is conferred in exchange for the investment and/or for jobs created using the investment to place employees with an employer. In some embodiments, periodic reports 130 describing the persistence or other properties of jobs created using the investment to place employees with an employer are generated to facilitate the citizenship, residency or immigration transaction. In some embodiments, audit client 114 provides an audit interface 112 for direct use by a government entity. In some embodiments, audit client 114 provides an audit interface 112 for use by a service provider interacting with a government entity, which may or may not be related to immigration transaction facilitation management provider 106. Some embodiments of reports 130 further include financial performance aspects of the investment, such as returns on investment or orders to complete financial transactions (e.g., payment of dividends or interest on the investment).

In one embodiment, an investment in an entity is recorded in a database 116 by the human resource allocation module 120, and a plurality of employment creation credits are allocated to the investment by the human resource allocation module 120. Some embodiments of human resource allocation module 120 perform and/or support recording one or more investments in one or more entities are recorded in an accounting system, allocating one or more economic metrics in the accounting system to the one or more investments, and facilitating execution of one or more immigration transactions by generating one or more records for ascertaining immigration compliance of the one or more investments with respect to the one or more immigration transactions. In some embodiments, human resource allocation module 120 performs the allocating in the accounting system the one or more economic metrics to the one or more investments, and the allocating further includes allocating in the accounting system one or more employment credits to the one or more investments through a co-employment arrangement. Likewise, in some embodiments, human resource allocation module 120 performs the facilitating execution of the one or more immigration transactions by the generating one or more records for ascertaining immigration compliance of the one or more investments with respect to the one or more immigration transactions, and the facilitating further includes allocating jobs created through the co-employment arrangement to an investor in a professional employment organization.

Some embodiments of human resource allocation module 120 perform and/or support monitoring one or more compliance properties of the plurality of employment creation credits. In some embodiments, the recording the investment in the entity by human resource allocation module 120 further includes calculating a contractually agreed return on the investment. In some embodiments, the allocating the plurality of employment creation credits by human resource allocation module 120 to the investment further includes identifying based on information received from employer client 102 a plurality of new jobs created with the investment, and generating documentation of the new jobs created with the investment in the form of reports 130.

Some embodiments further perform and/or support facilitating a citizenship, residency or immigration transaction by generating in reports 130 audit records for verifying compliance properties of the plurality of compliance credits. In some embodiments, the facilitating the citizenship, residency or immigration transaction by generating the audit records for verifying the compliance properties of the plurality of compliance credits further includes generating records in reports 130 for verifying persistence of jobs associated with the investment in the entity. In some embodiments, the facilitating the citizenship, residency or immigration transaction by generating the audit records for verifying the compliance properties of the plurality of compliance credits further includes generating records in reports 130 for verifying persistence of jobs associated with the investment in the entity. As described herein, the entity is the employer. In some embodiments, employees are then seconded or rented to a user of the employees, such as in a virtual workforce provider or PEO, as described below.

In one embodiment, the citizenship, residency or immigration transaction facilitated is an EB-5 visa transaction, or a similar investment-driven transaction for which employment is tracked. The EB-5 visa for Immigrant Investors is a United States visa created by the Immigration Act of 1990. The program is currently scheduled to end on Sep. 30, 2012, and embodiments similarly support replacement programs. This visa provides a method of obtaining a green card for foreign nationals who invest money in business entities in the United States. To obtain the visa, individuals invest $1,000,000 (or at least $500,000 in a “Targeted Employment Area”—high unemployment or rural area), creating or preserving at least ten jobs for U.S. workers excluding the investor and their immediate family. In some embodiments, employer interface 122 is used to report information about job creation for investments. Information about the investments is entered through audit client 114. Human resource allocation module 120 monitors and verifies compliance and provides reports 130.

Investments can be made directly in a job-generating commercial enterprise (new, or existing), or into a “Regional Center”—a 3rd party-managed investment vehicle (private or public), which assumes the responsibility of creating the requisite jobs. Any such investment recipient may operate or be supported by an immigration transaction facilitation management provider 106, which may further support billing for an administration fee for managing the investor's investment.

In some embodiments, human resource allocation module 120 supports monitoring and compliance reports for transactions created so as to facilitate approval of a visa, such that, if the foreign national investor's petition is approved, the investor and their dependents will be granted conditional permanent residence valid for two years. In some embodiments, reports 130 support filings required to, within the 90 day period before the conditional permanent residence expires, allow the investor to submit evidence documenting that the full required investment has been made and that 10 jobs have been maintained, or ten jobs have been created or will be created within a reasonable time period. Some embodiments further support transactions under the Startup Visa Act (projected EB-6 visa), introduced in Congress in 2010 and subsequently in 2011, which is planned to use unallocated numbers from the EB-5 visa. A person having ordinary skill in the art will readily comprehend, in light of having read the present disclosure, that the embodiments described herein with respect to the EB-5/EB-6 visa programs are non-limiting examples, and that other immigration transaction facilitation transactions, both within and outside of the immigration, residency, and citizenship space, fall within the scope of the described embodiments.

In some embodiments, immigration transaction facilitation management provider 106 is a system used by an employer or provides services to support an employer complying with the requirements of the EB-5 Visa program by tracking and accounting for employment credits in a manner used to comply with the EB-5 program. Embodiments include support for a PEO, or professional employer organization, which, in some embodiments is a company that provides HR-related services to clients through a business arrangement known as co-employment. Some embodiments provide accounting support specifically to monitor and account for EB-5/EB-6 compliance. Under this arrangement as supported by some embodiments, an investor invests in the PEO to create jobs and the PEO assumes or shares many of the responsibilities of being an employer, including EB-5/EB-6 compliance. Co-employment is the contractual arrangement between the client and the PEO that allows the PEO to provide a full range of services and to transfer or share many employer's liabilities, creating an investment vehicle that provides direct employment and then allows workers to be put to use on a flexible basis. In some embodiments, workers become employees of two employers. The client retains supervision for production or delivery of service, and the PEO assumes responsibility for human resources and personnel services. A PEO client retains control of the production by workers while the PEO supplements handles the details of employment and compliance with an EB-5 visa program or other immigration transaction facilitation programs executed using immigration transaction facilitation management provider 106.

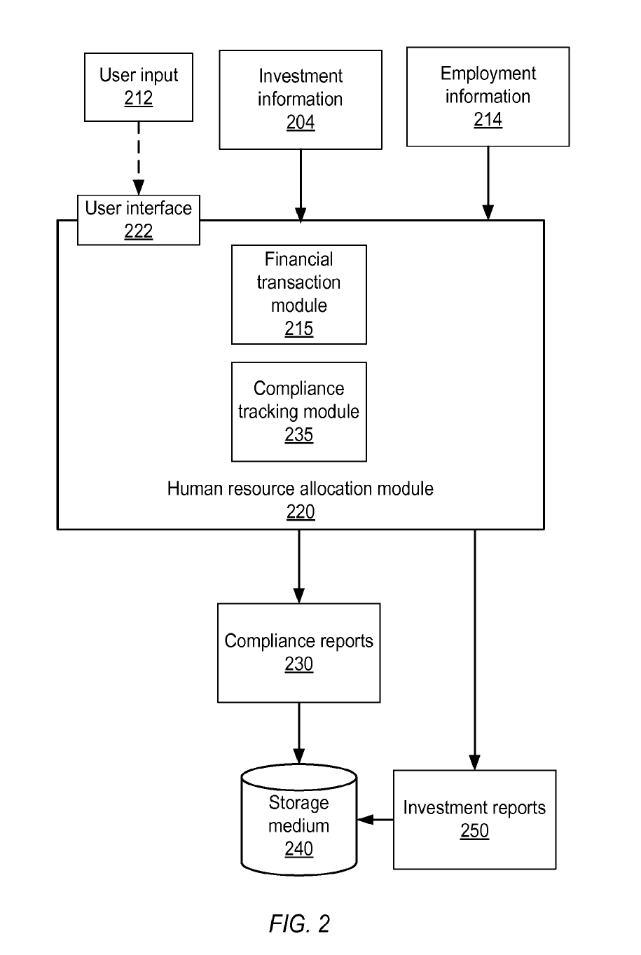

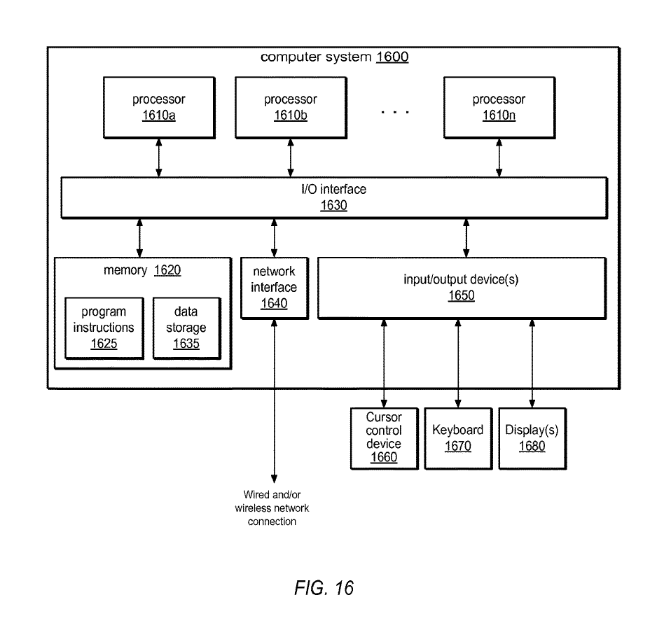

FIG. 2 illustrates a module that may implement facilitating immigration transactions using an accounting system for allocating employment credits, according to some embodiments. Human resource allocation module 220 may, for example, implement one or more of an investment recording tool, an employment credit creation allocation tool, a compliance monitoring tool, an accounting system for allocating employment credits, an accounting tool for allocating employment credits, a citizenship, residency or immigration transaction facilitation tool, and/or a record generation tool, for performing functions as described herein. FIG. 16 illustrates an example computer system on which embodiments of human resource allocation module 220 may be implemented. Human resource allocation module 220 receives as input one or more forms of investment information 204. Examples of investment information 204 may include terms of an investment or payment received from an investing party seeking a citizenship, residency or immigration transaction, such as a United States EB-5 visa transaction. Some embodiments further perform and/or support facilitating accounting records for tax preference transactions related to employment goals facilitated by investments. Human resource allocation module 220 further receives as input one or more forms of employment information 204. Examples of employment information 214 may include information for an investment received from an investing party to comply with terms of a citizenship, residency or immigration transaction, such as a United States EB-5 visa transaction. Examples of employment information 214 may include for reports of jobs created by a company receiving investment from an investing party, such that the employment information can be used to verify compliance with terms of a citizenship, residency or immigration transaction, such as a United States EB-5 visa transaction.

Human resource allocation module 220 may receive user input 212 activating an investment recording tool, an employment credit creation allocation tool, a compliance monitoring tool, a citizenship, an accounting tool for allocating employment credits, a residency or immigration transaction facilitation tool, and/or a record generation tool, for performing functions as described herein. Human resource allocation module 220 performs recording an investment in an entity and allocating a plurality of employment creation credits to the investment, as described herein. A compliance tracking module 235 performs monitoring one or more compliance properties of the plurality of employment creation credits and generating compliance reports, which may, for example, be stored to a storage medium 240, such as system memory, a disk drive, DVD, CD, etc.

A financial transaction module 215 performs financial reporting, which may include recording an investment in an entity and may further include calculating a contractually agreed return on the investment, as well as other functions described herein. Financial transaction module 215 generates investment reports describing financial aspects of transactions.

In some embodiments, human resource allocation module 220 performs preparing data for use in an immigration compliance report. In some embodiments, financial transaction module 215 performs reporting one or more employment credits as being allocated to an investment. In some embodiments, the employment credits represent jobs created through investment in a first business entity that employs one or more employees that are simultaneously employees of the first business entity and a second business entity. In some embodiments, reporting one or more employment credits as being allocated to an investment further includes reporting one or more employment credits as being allocated to an investment from a foreign investor. In some embodiments, reporting one or more employment credits as being allocated to an investment further includes reporting one or more employment credits as being allocated to an investment from a foreign investor in the first business entity without investment by the investor in the second business entity. In some embodiments, reporting one or more employment credits as being allocated to an investment further comprises reporting one or more employment credits as being allocated to an investment from a foreign investor in the first business, and the second business entity is a recipient of investment by the first business entity.

In some embodiments, compliance tracking module 235 performs identifying the one or more employees that are simultaneously employees of the first business entity and a second business entity as holding jobs created by the investment in the first business entity. In some embodiments, the investment compliance report includes information regarding investment by a non-U.S. resident seeking to comply with U.S. immigration rules regarding residency. In some embodiments, the investment compliance report is automatically prepared using a computer system. In some embodiments, the first organization is a professional employment organization, and at least one of the employees of the first organization is co-employed by the second organization. In some embodiments, one or more of the employees is co-employed by the first organization and the second organization.

In some embodiments, financial transaction module 215 performs recording in an accounting system one or more investments in one or more entities and exclusively allocating in the accounting system one or more economic metrics to the one or more investments. In some embodiments, the allocating in the accounting system the one or more economic metrics to the one or more investments includes allocating in the accounting system one or more employment credits to the one or more investments through a co-employment arrangement. In some embodiments, financial transaction module 215 performs calculating a contractually agreed return on the one or more investments. In some embodiments, financial transaction module 215 performs calculating one or more contractually agreed returns on the one or more investments, and generating one or more records for reporting the one or more contractually agreed returns on the one or more investments.

In some embodiments, compliance tracking module 235 performs generating one or more records for ascertaining immigration compliance of the one or more investments with respect to the one or more immigration transactions. In some embodiments, the facilitating execution of the one or more immigration transactions by the generating one or more records for ascertaining immigration compliance of the one or more investments with respect to the one or more immigration transactions further includes allocating jobs created through the co-employment arrangement to an investor in a professional employment organization. In some embodiments the facilitating the execution of the one or more immigration transactions by generating one or more records for ascertaining the immigration compliance of the one or more investments with respect to the one or more immigration transactions includes ascertaining the immigration compliance of the one or more investments based at least in part upon the economic metrics.

In some embodiments the facilitating the execution of the one or more immigration transactions by generating one or more records for ascertaining the immigration compliance of the one or more investments with respect to the one or more immigration transactions further includes generating one or more reports complying with immigration authority regulations. In some embodiments the facilitating the execution of the one or more immigration transactions by generating one or more records for ascertaining the immigration compliance of the one or more investments with respect to the one or more immigration transactions further includes generating one or more reports documenting compliance with immigration authority regulations. In some embodiments the facilitating the execution of the one or more immigration transactions by generating one or more records for ascertaining the immigration compliance of the one or more investments with respect to the one or more immigration transactions further includes generating an accounting report for documenting compliance with taxation regulations. In some embodiments, the facilitating the execution of the one or more immigration transactions by generating one or more records for ascertaining the immigration compliance of the one or more investments with respect to the one or more immigration transactions further includes generating one or more records for verifying persistence of jobs associated with the one or more investments in the one or more entities. In some embodiments the allocating in the accounting system the one or more economic metrics to the one or more investments further includes identifying a plurality of new jobs created with the one or more investments and generating documentation of the new jobs created with the one or more investments.

In some embodiments financial transaction module 215 performs calculating a contractually agreed return on the investment. In some embodiments compliance tracking module 235 may perform facilitating a citizenship, residency or immigration transaction by generating audit records for verifying compliance properties of the plurality of compliance credits as part of compliance reports 230. In some embodiments compliance tracking module 235 may perform generating audit records for verifying the compliance properties of the plurality of compliance credits, which in some embodiments further includes generating records for verifying from employment information 214 persistence of jobs associated with the investment in the entity and generating records for verifying persistence of jobs associated with the investment in the entity. In some embodiments compliance tracking module 235 may perform identifying a plurality of new jobs created with the investment and generating documentation of the new jobs created with the investment.

In some embodiments, human resource allocation module 220 is an electronic accounting system. In some embodiments, human resource allocation module 220 performs aggregating and allocating job credits used for immigration regulatory compliance. Financial transaction module 215 allows investments to be provided from two or more qualified immigrants to a first entity. The first entity hires two or more employees who then provide services to a second entity, and the services are provided in exchange for consideration being provided by the second entity to the first entity. Compliance tracking module 235 aggregates in an electronic accounting system job credits for immigration regulatory compliance to the first entity, based on the employment of the two or more employees and allocates in the electronic accounting system at least two of the job credits to two or more of the qualified immigrants, for the purposes of immigration regulatory compliance of two or more of the qualified immigrants.

In some embodiments of human resource allocation module 220, the allocating is performed automatically by the electronic accounting system, after receipt of job credits into the accounting system. Some embodiments of compliance tracking module 235 automatically allocate job credits in the accounting system based on the length of time available to an immigrant to comply with an immigration regulatory requirement. In some embodiments, compliance tracking module 235 automatically allocates job credits in the accounting system based on the length of time available to an immigrant to comply with an immigration regulatory requirement, with allocations being first made to immigrants that have the least amount of time available to comply with an immigration regulatory requirement.

In some embodiments, aggregating is performed automatically by the electronic accounting system, after receipt of job credits into the accounting system. In some embodiments, at least some of the job credits are aggregated for immigration regulatory compliance to the first entity from a third entity, and services are provided to the third entity in exchange for consideration being paid by the third entity to the first entity. In some embodiments, at least some of the job credits are aggregated for immigration regulatory compliance to the first entity from a third entity, services are provided to the third entity in exchange for consideration being paid by the third entity to the first entity, and job credits from the second entity and job credits from the third entity are provided to an immigrant.

In some embodiments, human resource allocation module 220 automatically tracks in the accounting system allocated job credits to two or more qualified immigrants, from a second entity and a third entity, over a period of time. In some embodiments compliance tracking module 235 automatically receives data regarding the two or employees into the accounting system. In some embodiments, human resource allocation module 220 is configured to support or perform using the accounting system to prepare an immigration regulatory compliance report. In some embodiments, compliance tracking module 235 is configured to support or perform automatically ensuring that job credits for any employee are only applied as a job credit for one immigrant.

In some embodiments, human resource allocation module 220 automatically creates at least a portion of an immigration regulatory compliance report. Financial transaction module 215 allows investments to be provided from two or more qualified immigrants to a first entity. The first entity hires two or more employees who then provide services to a second entity, and the services are provided in exchange for consideration being paid by the second entity to the first entity. In some embodiments, human resource allocation module 220 receives in an electronic accounting system job credits for immigration regulatory compliance to the first entity, based on the employment of the two or more employees. In some embodiments, compliance tracking module 235 applies in the electronic accounting system two or more of the job credits to two or more of the qualified immigrants, for the purposes of immigration regulatory compliance of two or more of the qualified immigrants. In some embodiments, compliance tracking module 235 uses the applied job credits to automatically create at least a portion of an immigration regulatory compliance report. In some embodiments, compliance tracking module 235 automatically provides information pertaining to an immigration regulatory compliance report to a regulatory agency. In some embodiments, the applying is performed automatically by the electronic accounting system, after receipt of job credits into the accounting system. In some embodiments, compliance tracking module 235 automatically ensures that job credits for any employee are only applied as a job credit for one immigrant.

In some embodiments, one or more of the employees is co-employed by the first entity and the second entity. In some embodiments, financial transaction module 215 allows investments to be provided from two or more qualified immigrants to the first entity without allowing investments to be provided from two or more qualified immigrants to the second entity.

In some embodiments, human resource allocation module 220 performs aggregating and allocating job credits used for immigration regulatory compliance. In some embodiments, financial transaction module 215 allows investments to be provided from two or more qualified immigrants to a first entity, wherein a first entity hires two or more employees who then provide services to a second entity, and the services are provided in exchange for consideration being paid by the second entity to the first entity. Compliance tracking module 235 aggregates in a processor system job credits for immigration regulatory compliance to the first entity, based on the employment of the two or more employees. Compliance tracking module 235 allocates in the processor system at least two of the job credits to two or more of the qualified immigrants, for the purposes of immigration regulatory compliance of two or more of the qualified immigrants.

In some embodiments, compliance tracking module 235 automatically provides information pertaining to an immigration regulatory compliance report to a regulatory agency. In some embodiments, compliance tracking module 235 automatically aggregates job credits after a receipt of job credits into the processor system. In some embodiments, compliance tracking module 235 automatically ensures that job credits for any employee are only applied as a job credit for one immigrant. In some embodiments, one or more of the employees is co-employed by the first entity and the second entity.

In some embodiments, human resource allocation module 220 automatically creates at least a portion of an immigration regulatory compliance report. Financial transaction module 215 allows investments to be provided from two or more qualified immigrants to a first entity, wherein the first entity hires two or more employees who then provide services to a second entity, and the services are provided in exchange for consideration being paid by the second entity to the first entity. Compliance tracking module 235 receives in a processor job credits for immigration regulatory compliance to the first entity, based on the employment of the two or more employees. Compliance tracking module 235 applies in the processor two or more of the job credits to two or more of the qualified immigrants, for the purposes of immigration regulatory compliance of two or more of the qualified immigrants, and uses the applied job credits to automatically create at least a portion of an immigration regulatory compliance report.

In some embodiments, human resource allocation module 220 uses one or more processors to perform preparing data for use in an immigration compliance report. The preparing the data for use in the immigration compliance report includes reporting one or more employment credits as being allocated to an investment. The employment credits represent jobs created through investment in a first business entity that employs one or more employees that are providing services to a second business entity. The preparing the data for use in the immigration compliance report further includes identifying the one or more employees that are employees of the first business entity, and providing services to the second business entity, as holding jobs created by the investment in the first business entity.

### Example Operations for Facilitating Immigration Transactions

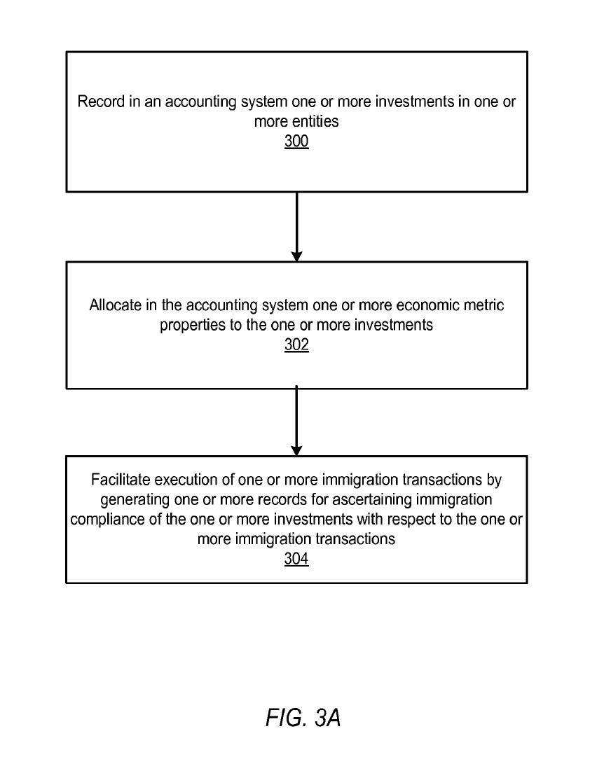

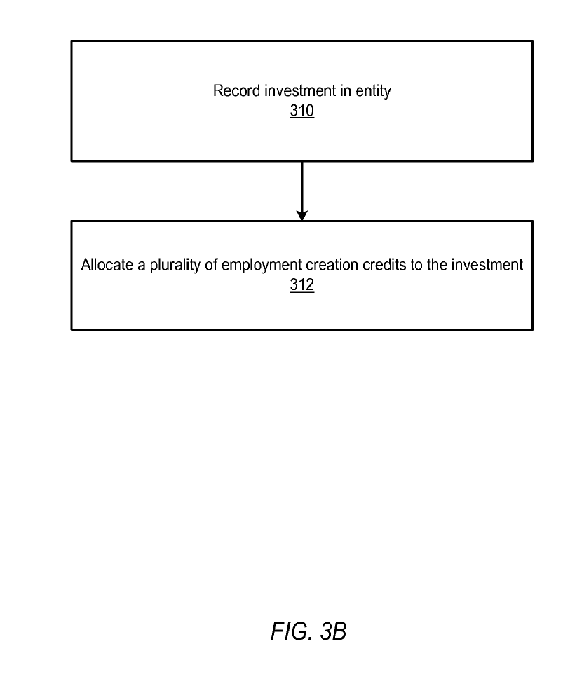

FIG. 3A is a high-level logical flowchart of a set of operations used in facilitating immigration transactions using an accounting system for allocating employment credits, according to some embodiments. One or more investments in one or more entities are recorded in an accounting system (block 300). As used herein, investments are commitments of funds or resources as an asset or item that is purchased with the hope that it will generate income or appreciate in the future. Examples of investments include but are not limited to cash, equity, any form of debt, loans, grants, convertible debt, revenue capital, promissory notes, lines of credit, transfer of commodities, and mezzanine financing. One or more economic metrics are allocated in the accounting system to the one or more investments (block 302). In some embodiments, the allocating includes exclusively allocating the economic metrics to one or more investments from a single investor. As used herein, economic metrics are quantitative indicators of economic improvement. Economic metrics include but not limited to numbers representing jobs created or saved, local unemployment rates, profitability of a business, changes in net worth of a business, or categories of employees (e.g., preferential hiring statuses (women, students, veterans, minorities). In some embodiments, jobs can include but are not limited to full time workers or opportunities, part time workers or opportunities, full time equivalent, part time equivalent, paid and unpaid internships, work study programs, mentorship programs, apprenticeship programs, full-time contractors, part-time contractors, outsourced positions, and volunteer positions.

Execution of one or more immigration transactions is facilitated by generating one or more records for ascertaining immigration compliance of the one or more investments with respect to the one or more immigration transactions (block 304). As used herein, an immigration transaction is a process for granting of any form of legal immigration status upon the foreign investor or investors including but not limited to Visas (investor, visitor, and student), temporary or permanent residence permission.

FIG. 3B is a high-level logical flowchart of operations used in facilitating immigration transactions using an accounting system for allocating employment credits, according to some embodiments. An investment in an entity is recorded (block 310). A plurality of employment creation credits are allocated to the investment (block 312).

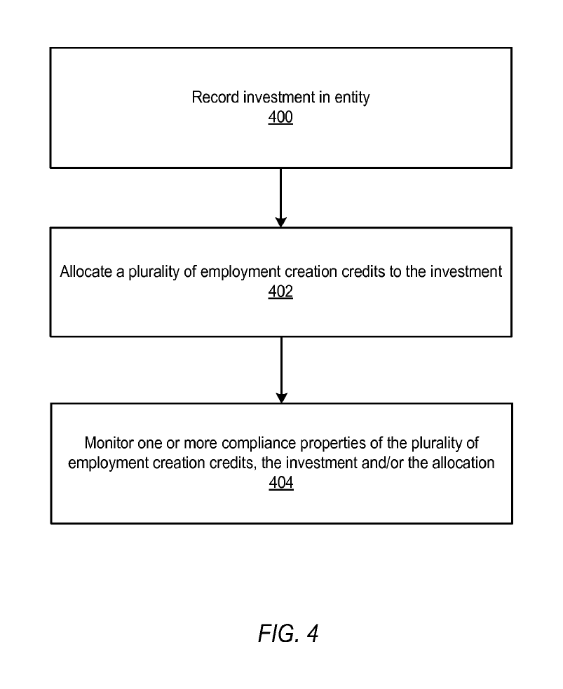

FIG. 4 is a high-level logical flowchart of operations used in facilitating immigration transactions using an accounting system for allocating employment credits, according to some embodiments. An investment in an entity is recorded (block 400). A plurality of employment creation credits are allocated to the investment (block 402). Monitoring is performed with respect to one or more compliance properties of the plurality of employment creation credits, the investment, or the allocation (block 404).

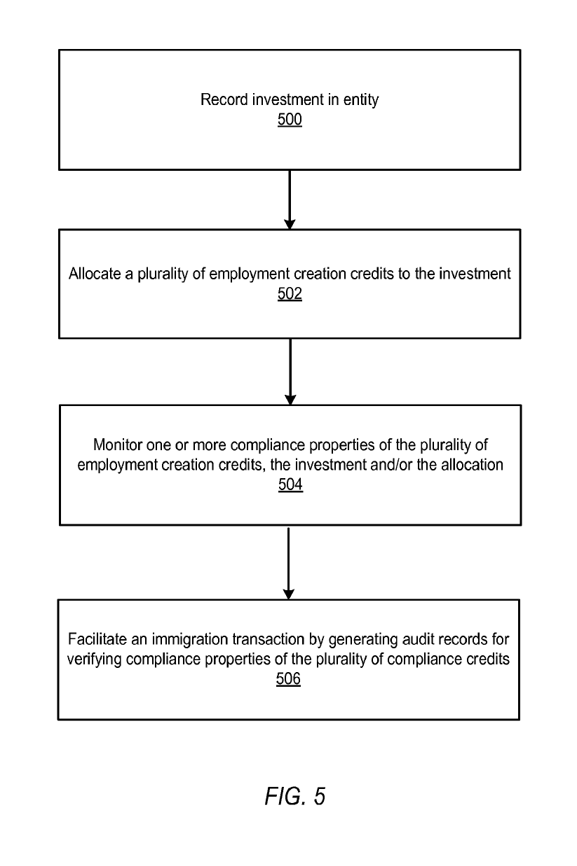

FIG. 5 is a high-level logical flowchart of operations used in immigration transaction facilitation and monitoring to facilitate a citizenship, residency or immigration transaction, according to some embodiments. An investment in an entity is recorded (block 500). A plurality of employment creation credits are allocated to the investment (block 502). Monitoring is performed with respect to one or more compliance properties of the plurality of employment creation credits, the investment, or the allocation (block 504). A citizenship, residency or immigration transaction is facilitated by generating audit records for verifying compliance properties of the plurality of compliance credits (block 506).

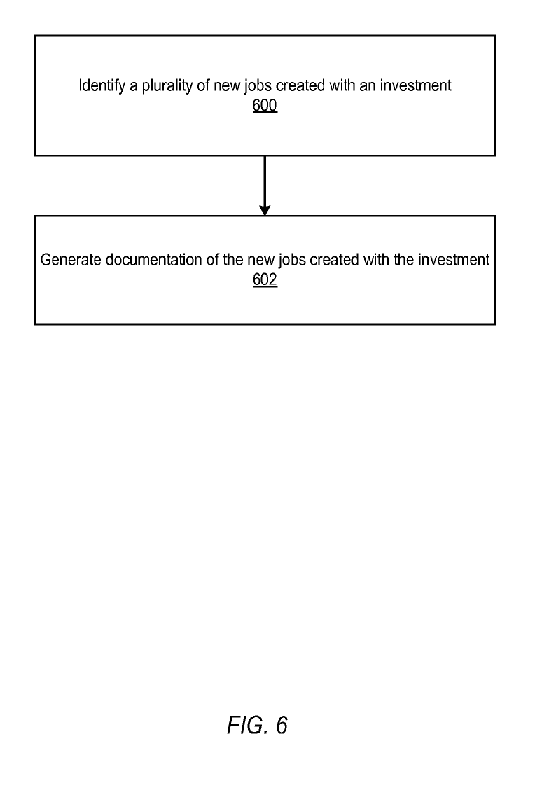

FIG. 6 is a high-level logical flowchart of operations used in immigration transaction facilitation and monitoring to facilitate a citizenship, residency or immigration transaction, according to some embodiments. A plurality ofjobs created with an investment is identified (block 600). Documentation of the new jobs created with the investment is generated (block 602).

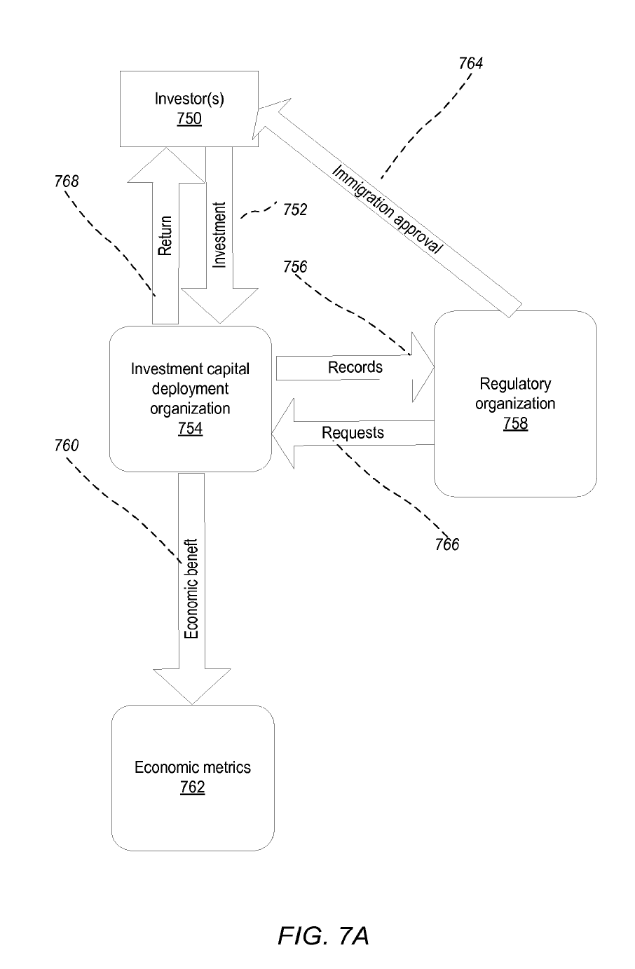

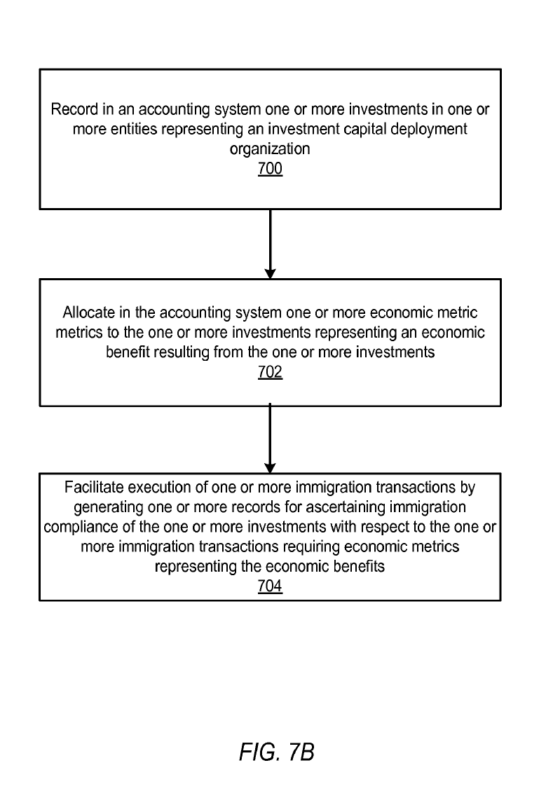

FIG. 7A illustrates a business model that may be implemented using a system for facilitating immigration transactions using an accounting system for allocating employment credits, according to some embodiments. Investors 750 provide investments 752 to an investment capital deployment organization 754 (e.g., immigration facilitation management provider 106 of FIG. 1). As used herein, investments are commitments of funds or resources as an asset or item that is purchased with the hope that it will generate income or appreciate in the future. Examples of investments include but are not limited to cash, equity, any form of debt, loans, grants, convertible debt, revenue capital, promissory notes, lines of credit, transfer of commodities, or mezzanine financing. As used herein, an investor is a foreign individual or individuals seeking placement of an investment for the dual purpose an economic benefit and the facilitation of an immigration transaction.

As used herein, an investment capital deployment organization 754 is any organization for providing services related to facilitating immigration transactions through investment by immigrant investors. Such services include but are not limited to recording in an accounting system one or more investments in one or more entities, allocating in the accounting system one or more economic metrics to the one or more investments, and facilitating execution of one or more immigration transactions by generating one or more records for ascertaining immigration compliance of the one or more investments with respect to the one or more immigration transactions. Examples of investment capital deployment organization 754 may include but are not limited to for-profit and non-profit organizations, sole proprietorships, government entities, volunteer organizations, corporations, partnerships, limited liability companies, foundations, religious organizations, unions, and educational institutions (either private or public and for-profit or not-for profit). Examples of investment capital deployment organization 754 may take the form of any economic unit, public or private, which is involved with the promotion of economic growth, including increased export sales, improved regional productivity, job creation, or increased domestic capital investment, which in some embodiments may take the form of a regional center as defined by the USCIS.

An economic benefit 760 is measured in economic metrics 762. As used herein, an economic benefit is defined to include any transfer resulting in improvement to economic properties of a person or an entity including but not limited to jobs, access to working capital, loans, investments, and transfer of goods or commodities. Records 756 reflecting the economic benefit 760 through economic metrics 762 are provided to a regulatory organization 758 to facilitate immigration approval 764. As used herein, economic metrics 762 are quantitative indicators of economic improvement. Economic metrics 762 include but not limited to numbers representing jobs created or saved, local unemployment rates, profitability of a business, changes in net worth of a business, or categories of employees (e.g., preferential hiring statuses (women, students, veterans, or minorities). In some embodiments, jobs can include but are not limited to full time workers or opportunities, part time workers or opportunities, full time equivalent, part time equivalent, paid and unpaid internships, work study programs, mentorship programs, apprenticeship programs, full-time contractors, part-time contractors, outsourced positions, or volunteer positions. As used herein, immigration approval 764 is granting of any form of legal immigration status upon the foreign investor or investors including but not limited to visas (investor, visitor, and student), temporary permission or permanent residence permission.

In some embodiments, records 756 reflecting the economic benefit 760 through economic metrics are provided to a regulatory organization 758 in response to requests 766. Investment capital deployment organization 754 pays a return 768 to investors 750. As used herein regulatory organization 758 includes but is not limited to a local, state or federal government organization that can grant or recommend immigration approval of foreign investors for the granting of immigration credentials. Quasi-governmental organizations with regulatory or adjudicatory functions that can grant or recommend immigration approval to foreign investors for the granting of immigration credentials are also included. As used herein, a return is compensation for the use of funds or other payment involved in an investment, including but not limited to any class of stock, promissory notes, payments of dividends, payments of interest. As used herein, records include but are not limited to any and all forms of data recording either as raw data or the form of a finished report that is used to facilitate the granting of an immigration approval. These records or reports may conform to standards as defined by a regulator organization. These records also include the populating of standardized government forms with data collected by or in behalf of the employment organization. As used herein, queries include but are not limited to any and all requests for data from a regulatory organization to an employment organization that aid or assist the regulatory organization in performing its function.

FIG. 7B is a flowchart of operations that can be performed in execution of a business model that may be implemented using a system for facilitating immigration transactions using an accounting system for allocating employment credits, according to some embodiments. One or more investments in one or more entities representing an investment capital deployment organization are recorded in an accounting system (block 700). One or more economic metric metrics are allocated in the accounting system to the one or more investments representing an economic benefit resulting from the one or more investments (block 702). Execution of one or more immigration transactions is facilitated by generating one or more records for ascertaining immigration compliance of the one or more investments with respect to the one or more immigration transactions requiring economic metrics representing the economic benefits (block 704).

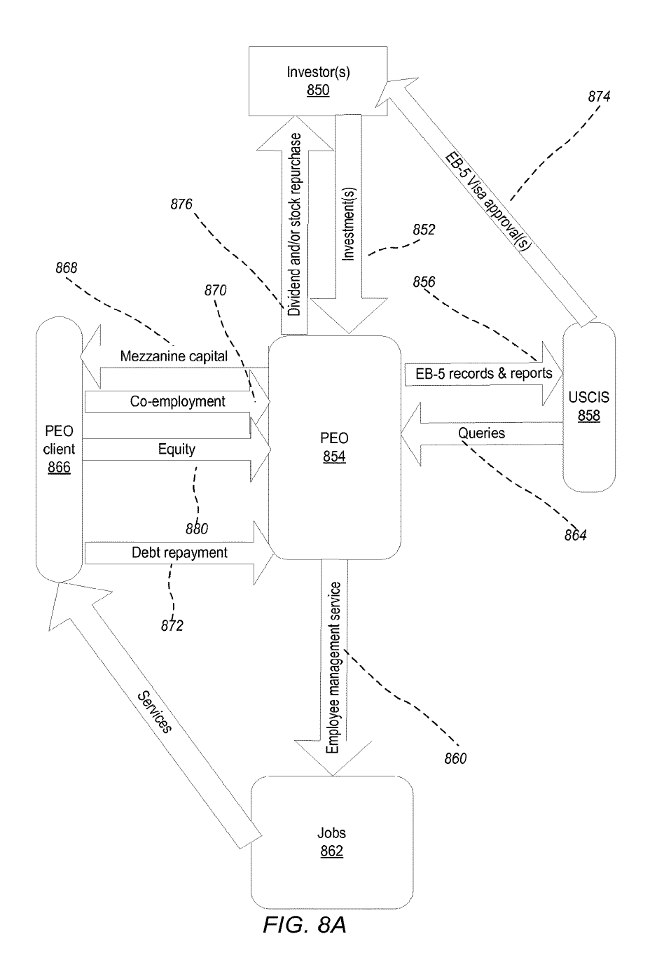

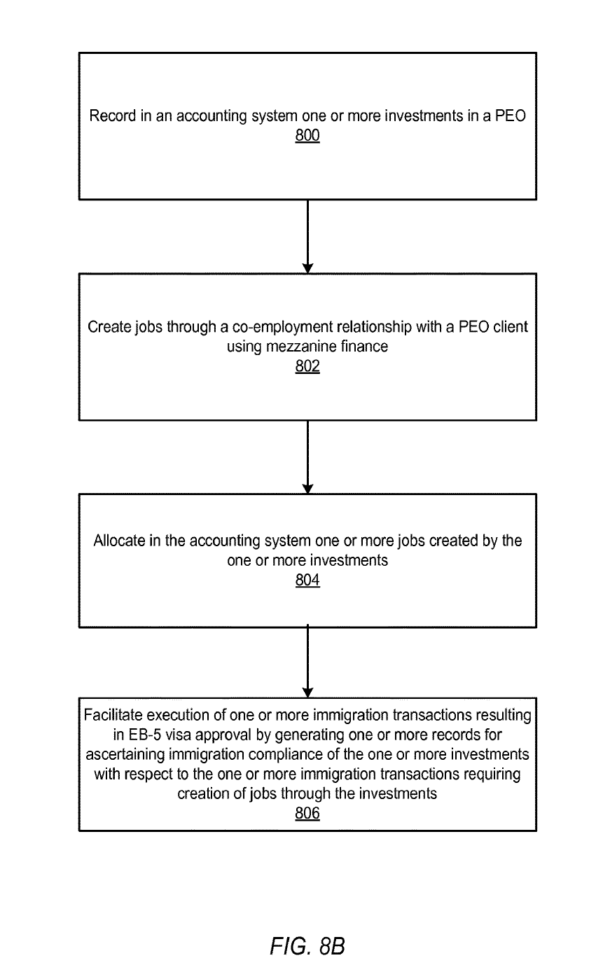

FIG. 8A depicts a business model that may be implemented using a system for immigration transaction facilitation and monitoring, according to some embodiments. Investors 850 provide one or more investments 852 to a professional employer organization (PEO) 854. As used herein, investments 852 are one or more purchases of shares in PEO 854 in an amount intended to fulfill or satisfy EB-5 Visa requirements. Referring briefly to FIG. 2, a financial transaction module 215 of a human resource allocation module 220, in some embodiments records in an accounting system one or more investments 852 in one or more entities.

As used herein, an investor 850 is a foreign individual or individuals seeking an EB-5 visa through placement of an investment. An investor is a qualified immigrant as defined at pages 2-3 of the article “EB-5 Immigrant Investors: A Detailed Analysis” by Stephen Yale-Loehr, Carolyn S. Lee, Nicolai Hinrichsen & Lindsay Schoonmaker in Immigration and Nationality Law Handbook 63 (2009), the content of article which is incorporated by reference for the purpose of providing this definition.

As used herein, a PEO (professional employer organization) 854 is a company that provides HR-related services to clients through a business arrangement known as co-employment, is used to facilitate the immigration transaction. In some embodiments, a PEO 854 also serves as an investment capital deployment organization, as discussed above, and performs functions including recording in an accounting system one or more investments in one or more entities, allocating in the accounting system one or more economic metrics to the one or more investments, and facilitating execution of one or more immigration transactions by generating one or more records for ascertaining immigration compliance of the one or more investments with respect to the one or more immigration transactions, as well as other functions described herein as functions of an immigration transaction facilitation management provider.

Investment in the PEO 854 is used to create jobs. Job creation credits are allocated to the investment. Some embodiments track allocation of the job creation credits to jobs in the PEO 854. Referring briefly to FIG. 2, a compliance tracking module 235 of a human resource allocation module 220, in some embodiments allocates in the accounting system one or more economic metrics to the one or more investments. In co-employment, PEO 854 becomes the employer of record for tax purposes, filing paperwork under its own identification numbers. The client company continues to direct the employees' day-to-day activities. In some embodiments, PEO 854 charges a service fee for taking over the human resources and payroll functions of the client company: typically, this is from 3 to 15% of total payroll. This fee is in addition to the normal employee overhead costs, such as the employer's share of FICA, Medicare, and unemployment insurance withholding.

In some embodiments, one service provided by a PEO 854 is to secure workers compensation insurance coverage at a lower cost than client companies can obtain on an individual basis. In such embodiments, PEO 854 obtains workers compensation coverage for its clients by negotiating insurance coverage that covers not just the PEO 854 but also the client companies, because legally the PEO 854 is the co-employer of the workers at the client companies. PEO 854 can also offer basic levels of background and drug screening.

In some embodiments, use of PEO 854 saves time and staff that would be used to prepare payroll and administer benefits plans, and may reduce legal liabilities or obligations to employees that it would otherwise have. PEO client company 866 may also be able to offer a better overall package of benefits, and thus attract more skilled employees. Several variations on the PEO model exist, differing in the nature of the relationship formed between PEO 854 and the PEO client 866, and are supported by embodiments described herein.

In one example variation, financial intermediaries, also called fiscal intermediaries, act as an employer of record for home healthcare workers who serve disabled persons. This streamlines the process of hiring such workers, because neither the household hiring them nor government units that provide funding need to take on the duties of an employer.

PEO 854 provides an employee management service 860 that generates jobs 862 for workers. Employment management service 860 is a co-employment hiring relationship as defined above. In some embodiments, jobs can include but are not limited to full time workers or opportunities, part time workers or opportunities, full time equivalent, part time equivalent, paid and unpaid internships, work study programs, mentorship programs, apprenticeship programs, full-time contractors, part-time contractors, outsourced positions, or volunteer positions. Examples of eligible jobs are explained at pages 8-9 of the article “EB-5 Immigrant Investors: A Detailed Analysis” by Stephen Yale-Loehr, Carolyn S. Lee, Nicolai Hinrichsen & Lindsay Schoonmaker in Immigration and Nationality Law Handbook 63 (2009), the content of article which is incorporated by reference for the purpose of providing this explanation.

A co-employment relationship 870 is created between PEO 854 and a PEO client 866. Co-employment is the contractual arrangement between PEO client 866 and PEO 854 that allows PEO 854 to provide a full range of services and to transfer or share many employer's liabilities, including EB-5/EB-6 compliance. Workers become employees of two employers; PEO client 866 retains supervision for production or delivery of service, and PEO 854 assumes responsibility for human resources and personnel services, including EB-5/EB-6 compliance. Simply put, PEO client 866 of PEO 854 retains full control of the workers while PEO 854 supplements handling of the details of employment and compliance with an EB-5 visa program or other employment compliance programs executed using embodiments.

Financial aspects of the relationship between PEO 854 and a PEO client 866 include provision of mezzanine capital 868 and debt repayment 872. In some embodiments, mezzanine capital 868 refers to a subordinated debt or preferred equity instrument that represents a claim on a company's assets which is senior only to that of the common shares. Mezzanine financings can be structured either as debt (typically an unsecured and subordinated note) or preferred stock. Mezzanine capital is often a more expensive financing source for a company than secured debt or senior debt. The higher cost of capital associated with mezzanine financings is the result of its location as an unsecured, subordinated (or junior) obligation in a company's capital structure (i.e., in the event of default, the mezzanine financing is less likely to be repaid in full after all senior obligations have been satisfied). Additionally, mezzanine financings, which are usually private placements, are often used by smaller companies and may involve greater overall leverage levels than issuers in the high-yield market; as such, they involve additional risk. In compensation for the increased risk, mezzanine debt holders require a higher return for their investment than secured or other more senior lenders.

PEO 854 receives equity 880 from PEO client 866. Equity can take many forms, including stocks, options, warrants, rights of refusal, etc. Mezzanine financings can be completed through a variety of different structures based on the specific objectives of the transaction and the existing capital structure in place at the company. The basic forms used in most mezzanine financings are subordinated notes and preferred stock. Mezzanine lenders, typically specialist mezzanine investment funds, look for a certain rate of return which can come from (each individual security can be made up of any of the following or a combination thereof):
Cash interest—A periodic payment of cash based on a percentage of the outstanding balance of the mezzanine financing. The interest rate can be either fixed throughout the term of the loan or can fluctuate (i.e., float) along with LIBOR or other base rates.
PIK interest—Payable in kind interest is a periodic form of payment in which the interest payment is not paid in cash but rather by increasing the principal amount by the amount of the interest (e.g., a $100 million bond with an 8% PIK interest rate will have a balance of $108 million at the end of the period but will not pay any cash interest).
Ownership—Along with the typical interest payment associated with debt, mezzanine capital will often include an equity stake in the form of attached warrants or a conversion feature, similar to that of a convertible bond. The ownership component in mezzanine securities is almost always accompanied by either cash interest or PIK interest and in many cases by both.

Mezzanine financings can be completed through a variety of different structures. Mezzanine lenders will also often charge an arrangement fee, payable upfront at the closing of the transaction. Arrangement fees contribute the least return and are aimed primarily to cover administrative costs and as an incentive to complete the transaction.

The following are illustrative examples of mezzanine financings:
$100,000,000 of senior subordinated notes with warrants (10% cash interest, 3% PIK interest and warrants representing 4% of the fully diluted ownership of the company).
$50,000,000 of redeemable preferred stock with warrants (0% cash interest, 14% PIK interest and warrants representing 6% of the fully diluted ownership of the company).

Mezzanine financings can be completed through a variety of different structures. In structuring a mezzanine security, the company and lender work together to avoid burdening the borrower with the full interest cost of such a loan. Because mezzanine lenders will seek a return of 14% to 20%, this return is achieved through means other than simply cash interest payments. As a result, by using equity ownership and PIK interest, the mezzanine lender effectively defers its compensation until the due date of the security or a change of control of the company. Mezzanine financings can be made at either the operating company level or at the level of a holding company (also known as structural subordination). In a holding company structure, as there are no operations and hence no cash flows, the structural subordination of the security and the reliance on cash dividends from the operating company introduces additional risk and typically higher cost. This approach is taken most often as a result of the structure of the company's existing capital structure.

As used herein, debt repayment 872 includes any and all payments from the PEO client 866 to the PEO 854 that fulfill some or all of the terms of the mezzanine capital.

Dividend and/or stock repurchase 876 is provided to investor 850. In some embodiments, the return on investment is achieved through a combination of dividends paid over time and/or stock repurchase from the PEO.

PEO 854 provides EB-5 records and reports 856 to USCIS 858, sometimes but not exclusively in response to queries 864. Referring briefly to FIG. 2, a compliance tracking module 235 of a human resource allocation module 220, in some embodiments facilitates execution of one or more immigration transactions by generating one or more records for ascertaining immigration compliance of the one or more investments with respect to the one or more immigration transactions.

Queries are any requests for documentation, data, documents, records, evidence, access to or identification of sources of relevant information, from the USCIS. Examples of queries are explained at page 12 of the article “EB-5 Immigrant Investors A Detailed Analysis” by Stephen Yale-Loehr, Carolyn S. Lee, Nicolai Hinrichsen & Lindsay Schoonmaker in Immigration and Nationality Law Handbook 63 (2009), the content of article which is incorporated by reference for the purpose of providing this explanation. Examples of EB-5 records and reports 856 to USCIS 858 are explained at pages 7-11 of the article “EB-5 Immigrant Investors: A Detailed Analysis” by Stephen Yale-Loehr, Carolyn S. Lee, Nicolai Hinrichsen & Lindsay Schoonmaker in Immigration and Nationality Law Handbook 63 (2009), the content of article which is incorporated by reference for the purpose of providing this explanation.

USCIS 858 reports EB-5 visa approval(s) 874 to investor 850. An example of EB-5 visa approval is explained at page 12 of the article “EB-5 Immigrant Investors: A Detailed Analysis” by Stephen Yale-Loehr, Carolyn S. Lee, Nicolai Hinrichsen & Lindsay Schoonmaker in Immigration and Nationality Law Handbook 63 (2009), the content of article which is incorporated by reference for the purpose of providing this explanation.

FIG. 8B is a flowchart of operations that can be performed in execution of a business model that may be implemented using a system for immigration transaction facilitation and monitoring, according to some embodiments. One or more investments in a PEO are recorded in an accounting system (block 800). Jobs are created through a co-employment relationship with a PEO client using mezzanine finance (block 802). One or more jobs created by the one or more investments in the PEO are allocated to the one or more investments in the accounting system (block 804). Execution of one or more immigration transactions resulting in EB-5 visa approval is facilitated by generating one or more records for ascertaining immigration compliance of the one or more investments with respect to the one or more immigration transactions requiring creation of jobs through the investments (block 806).

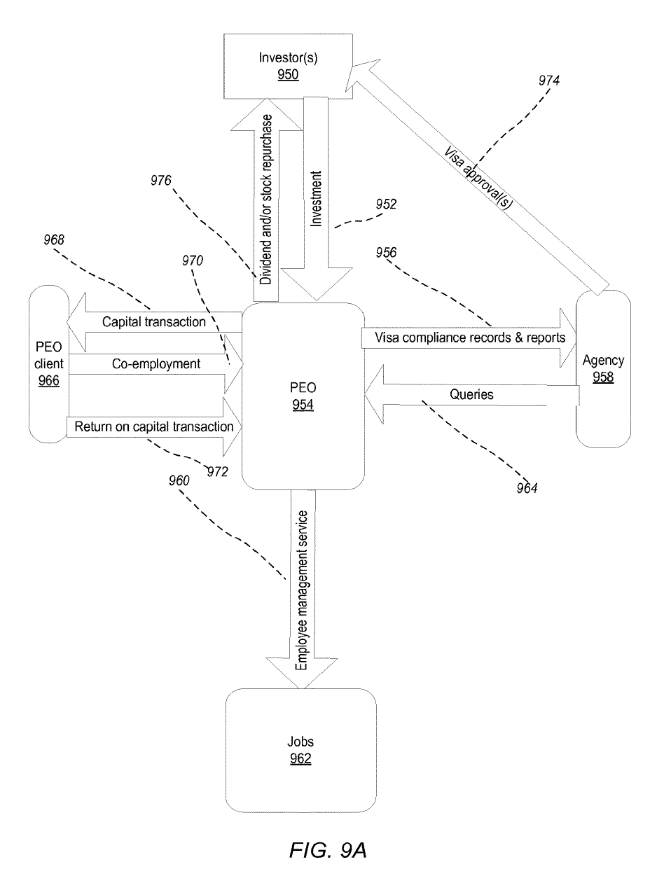

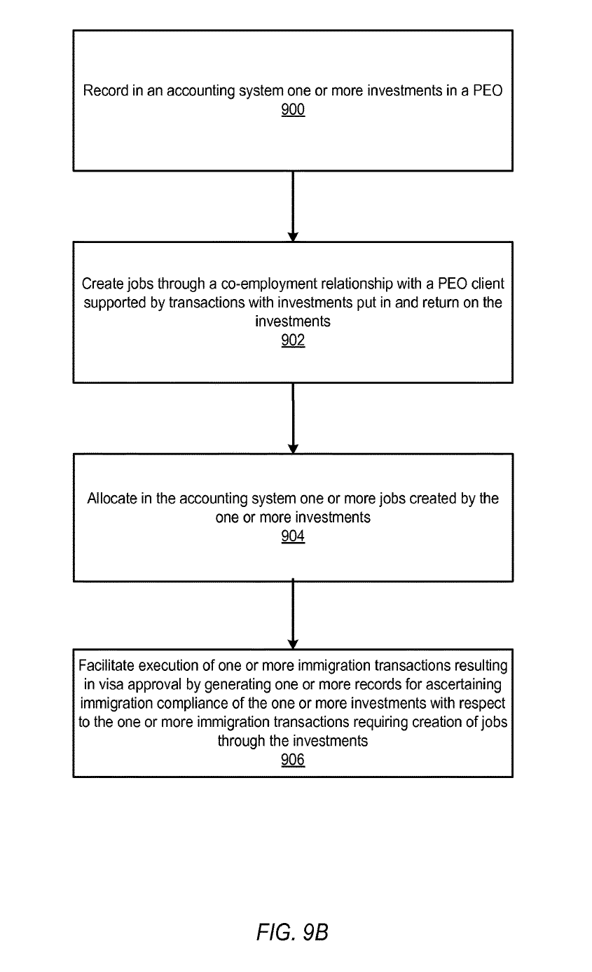

FIG. 9A illustrates a business model that may be implemented using a system for immigration transaction facilitation and monitoring, according to some embodiments. Investors 950 provide one or more investments 952 to a professional employer organization (PEO) 954. Referring briefly to FIG. 2, a financial transaction module 215 of a human resource allocation module 220, in some embodiments records in an accounting system one or more investments 952 in one or more entities. As used herein, investments 952 are one or more purchases of shares in PEO 954 in an amount intended to fulfill or satisfy immigration requirements.

As used herein, an investor 950 is a foreign individual or individuals seeking a visa through placement of an investment. An investor is a qualified immigrant as defined by applicable regulations promulgated by government authorities.

As used herein, a PEO (professional employer organization) 954 is a company that provides HR-related services to clients through a business arrangement known as co-employment, is used to facilitate the immigration transaction. In some embodiments, a PEO 954 also serves as an investment capital deployment organization, as discussed above, and performs functions including recording in an accounting system one or more investments in one or more entities, allocating in the accounting system one or more economic metrics to the one or more investments, and facilitating execution of one or more immigration transactions by generating one or more records for ascertaining immigration compliance of the one or more investments with respect to the one or more immigration transactions, as well as other functions described herein as functions of an immigration transaction facilitation management provider.

Investment in the PEO 954 is used to create jobs. Job creation credits are allocated to the investment. Referring briefly to FIG. 2, a compliance tracking module 235 of a human resource allocation module 220, in some embodiments allocates in the accounting system one or more economic metrics to the one or more investments. Some embodiments track allocation of the job creation credits to jobs in the PEO 954. In co-employment, PEO 954 becomes the employer of record for tax purposes, filing paperwork under its own identification numbers. Several variations on the PEO model exist, differing in the nature of the relationship formed between PEO 954 and the PEO client 966.

In one example variation, financial intermediaries, also called fiscal intermediaries, act as an employer of record for home healthcare workers who serve disabled persons. This streamlines the process of hiring such workers, because neither the household hiring them nor government units that provide funding need to take on the duties of an employer.

PEO 954 provides an employee management service 960 that generates jobs 962 for workers. Employment management service is a co-employment hiring relationship as defined above. In some embodiments, jobs can include but are not limited to full time workers or opportunities, part time workers or opportunities, full time equivalent, part time equivalent, paid and unpaid internships, work study programs, mentorship programs, apprenticeship programs, full-time contractors, part-time contractors, outsourced positions, or volunteer positions. Examples of eligible jobs are defined by applicable immigration regulations.

A co-employment relationship 970 is created between PEO 954 and a PEO client 966. Co-employment is the contractual arrangement between PEO client 966 and PEO 954 that allows PEO 954 to provide a full range of services and to transfer or share many employer's liabilities, including immigration compliance. Workers become employees of two employers: PEO client 966 retains supervision for production or delivery of service, and PEO 954 assumes responsibility for human resources and personnel services, including immigration compliance.

Financial aspects of the relationship between PEO 954 and a PEO client 966 include a capital transaction 968 and a return on capital transaction 972. As used herein, capital transaction 968 includes a purchase of equity. As used herein, return on equity transaction 972 includes any and all payments that generate capital gains or other sale of equity.

Dividend and/or stock repurchase 976 is provided to investor 950. In some embodiments, the return on investment is achieved through a combination of dividends paid over time and/or stock repurchase from the PEO.

PEO 954 provides visa compliance records and reports 956 to agency 958, sometimes but not exclusively in response to queries 964. Referring briefly to FIG. 2, a compliance tracking module 235 of a human resource allocation module 220, in some embodiments facilitates execution of one or more immigration transactions by generating one or more records for ascertaining immigration compliance of the one or more investments with respect to the one or more immigration transactions. Queries are any requests for documentation, data, documents, records, evidence, access to or identification of sources of relevant information, from agency 958. Agency 958 includes but is not limited to local, state or federal government organizations that can grant or recommend immigration approval of foreign investors for the granting of immigration credentials. Quasi-governmental organizations with regulatory or adjudicatory functions that can grant or recommend immigration approval to foreign investors for the granting of immigration credentials are also included.

Agency 958 reports visa approval(s) 974 to investor 950. As used herein, visa approval 974 is granting of any form of legal immigration status upon the foreign investor or investors including but not limited to Visas (investor, visitor, student), temporary or permanent residence permission.

FIG. 9B is a flowchart of operations that can be performed in execution of a business model that may be implemented using a system for immigration transaction facilitation and monitoring, according to some embodiments. One or more investments in a PEO is recorded in an accounting system (block 900). Jobs are created through a co-employment relationship with a PEO client supported by transactions with investments put in and return on the investments (block 902). One or more jobs created by the one or more investments are allocated to the one or more investments in the accounting system (block 904). Execution of one or more immigration transactions resulting in visa approval is facilitated by generating one or more records for ascertaining immigration compliance of the one or more investments with respect to the one or more immigration transactions requiring creation of jobs through the investments (block 906).

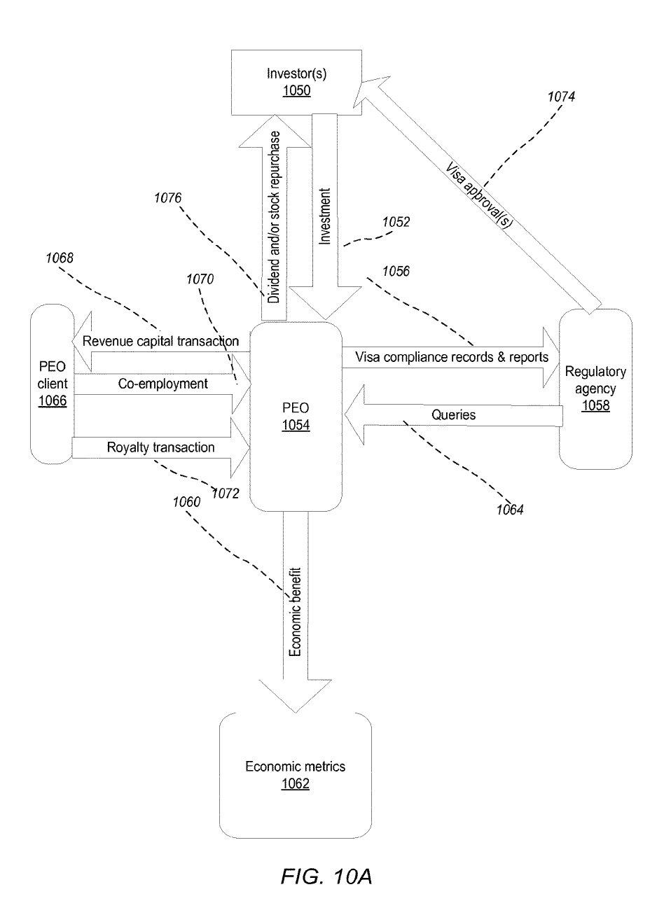

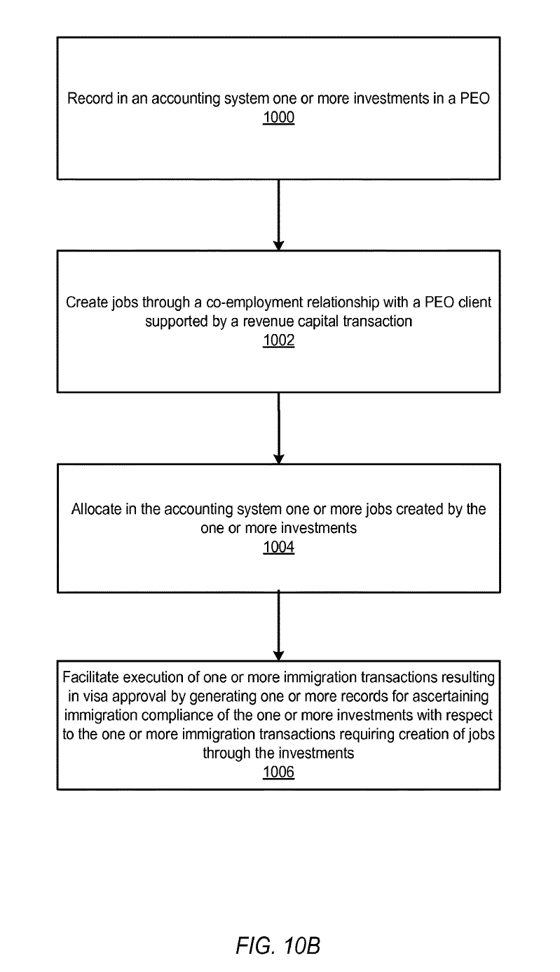

FIG. 10A illustrates a business model that may be implemented using a system for immigration transaction facilitation and monitoring, according to some embodiments. Investors 1050 provide one or more investments 1052 to a professional employer organization (PEO) 1054. As used herein, investments 1052 are one or more purchases of shares in PEO 1054 in an amount intended to fulfill or satisfy immigration requirements. Referring briefly to FIG. 2, a financial transaction module 215 of a human resource allocation module 220, in some embodiments records in an accounting system one or more investments 1052 in one or more entities.

As used herein, an investor 1050 is a foreign individual or individuals seeking a visa through placement of an investment. An investor is a qualified immigrant as defined by applicable regulations promulgated by government authorities.

As used herein, a PEO (professional employer organization) 1054 is a company that provides HR-related services to clients through a business arrangement known as co-employment, which is used to facilitate the immigration transaction. In some embodiments, a PEO 1054 also serves as an investment capital deployment organization, as discussed above, and performs functions including recording in an accounting system one or more investments in one or more entities, allocating in the accounting system one or more economic metrics to the one or more investments, and facilitating execution of one or more immigration transactions by generating one or more records for ascertaining immigration compliance of the one or more investments with respect to the one or more immigration transactions, as well as other functions described herein as functions of an immigration transaction facilitation management provider.

Investment in the PEO 1054 is used to create jobs. Job creation credits are allocated to the investment. Referring briefly to FIG. 2, a compliance tracking module 235 of a human resource allocation module 220, in some embodiments allocates in the accounting system one or more economic metrics to the one or more investments. Some embodiments track allocation of the job creation credits to jobs in the PEO 1054. In co-employment, PEO 1054 becomes the employer of record for tax purposes, filing paperwork under its own identification numbers. Several variations on the PEO model exist, differing in the nature of the relationship formed between PEO 1054 and the PEO client 1066.

PEO 1054 provides an economic benefit 1060 that generates economic metrics 1062. As used herein, an economic benefit 1060 is defined to include any transfer resulting in improvement to economic properties of a person or an entity including but not limited to jobs, access to working capital, loans, investments, and transfer of goods or commodities. As used herein, economic metrics 1062 are quantitative indicators of economic improvement. Economic metrics 1062 include but not limited to numbers representing jobs created or saved, local unemployment rates, profitability of a business, changes in net worth of a business, or categories of employees (e.g., preferential hiring statuses (women, students, veterans, minorities). In some embodiments, jobs can include but are not limited to full time workers or opportunities, part time workers or opportunities, full time equivalent, part time equivalent, paid and unpaid internships, work study programs, mentorship programs, apprenticeship programs, full-time contractors, part-time contractors, outsourced positions, volunteer positions. As used herein, immigration approval 1064 is granting of any form of legal immigration status upon the foreign investor or investors including but not limited to visas (investor, visitor, and student), temporary or permanent residence permission.

A co-employment relationship 1070 is created between PEO 1054 and a PEO client 1066. Co-employment is the contractual arrangement between PEO client 1066 and PEO 1054 that allows PEO 1054 to provide a full range of services and to transfer or share many employer's liabilities, including immigration compliance. Workers become employees of two employers: PEO client 1066 retains supervision for production or delivery of service, and PEO 1054 assumes responsibility for human resources and personnel services, including immigration compliance.

Financial aspects of the relationship between PEO 1054 and a PEO client 1066 include a revenue capital transaction 1068 and a royalty transaction 1072. As used herein, revenue capital transaction 1068 includes business financing based primarily on the sale or exchange of revenue streams. RC includes royalty-based financing, top-line income rights and a variety of other revenue-centric funding structures.

For example, an RC investor may provide a business unit with $250K in exchange for a 3% of the revenue of the business unit over a specified period of time, or until a specific payback amount is received. Regardless of the specific deal terms, RC encompasses funding structures where future revenue is the primary means of repayment. In some embodiments, revenue capital transactions function without the use of balance-sheet debt or traditional equity. In some embodiments, payments are divided between return to capital and a patent royalty. As used herein, royalty transaction 1072 includes both repayment of capital and royalty payments.

Dividend and/or stock repurchase 1076 is provided to investor 1050. In some embodiments, the return on investment is achieved through a combination of dividends paid over time and/or stock repurchase from the PEO.

PEO 1054 provides visa compliance records and reports 1056 to regulatory agency 1058, sometimes but not exclusively in response to queries 1064. Referring briefly to FIG. 2, a compliance tracking module 235 of a human resource allocation module 220, in some embodiments facilitates execution of one or more immigration transactions by generating one or more records for ascertaining immigration compliance of the one or more investments with respect to the one or more immigration transactions. Queries are any requests for documentation, data, documents, records, evidence, access to or identification of sources of relevant information, from regulatory agency 1058. Regulatory agency 1058 includes but is not limited to a local, state and federal government organizations that can grant or recommend immigration approval of foreign investors for the granting of immigration credentials. Quasi-governmental organizations with regulatory or adjudicatory functions that can grant or recommend immigration approval to foreign investors for the granting of immigration credentials are also included.

Regulatory agency 1058 reports visa approval(s) 1074 to investor 1050. As used herein, visa approval 1074 is granting of any form of legal immigration status upon the foreign investor or investors including but not limited to visas (investor, visitor, and student), temporary or permanent residence permission.

FIG. 10B is a flowchart of operations that can be performed in execution of a business model that may be implemented using a system for immigration transaction facilitation and monitoring, according to some embodiments. One or more investments in a PEO is recorded in an accounting system (block 1000). Jobs are created through a co-employment relationship with a PEO client supported by a revenue capital transaction (block 1002). One or more jobs created by the one or more investments are allocated to the one or more investments by the accounting system (block 1004). Execution of one or more immigration transactions resulting in visa approval is facilitated by generating one or more records for ascertaining immigration compliance of the one or more investments with respect to the one or more immigration transactions requiring creation of jobs through the investments (block 1006).

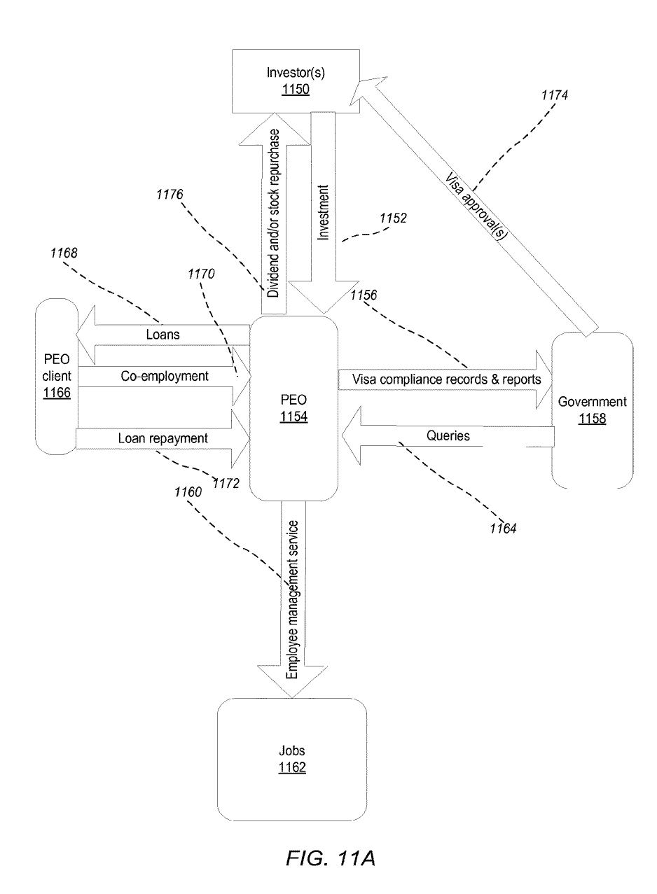

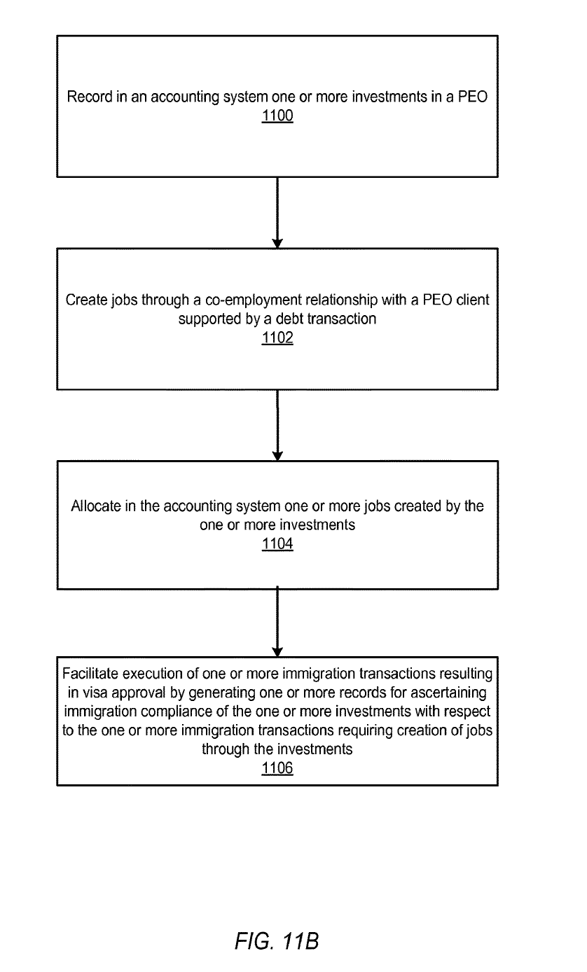

FIG. 11A illustrates a business model that may be implemented using a system for immigration transaction facilitation and monitoring, according to some embodiments. Investors 1150 provide one or more investments 1152 to a professional employer organization (PEO) 1154. As used herein, investments 1152 are one or more purchases of shares in PEO 1154 in an amount intended to fulfill or satisfy immigration requirements. Referring briefly to FIG. 2, a financial transaction module 215 of a human resource allocation module 220, in some embodiments records in an accounting system one or more investments 1152 in one or more entities.

As used herein, an investor 1150 is a foreign individual or individuals seeking a visa through placement of an investment. An investor is a qualified immigrant as defined by applicable regulations promulgated by government authorities.

As used herein, a PEO (professional employer organization) 1154 is a company that provides HR-related services to clients through a business arrangement known as co-employment, is used to facilitate the immigration transaction. In some embodiments, a PEO 1154 also serves as an investment capital deployment organization, as discussed above, and performs functions including recording in an accounting system one or more investments in one or more entities, allocating in the accounting system one or more economic metrics to the one or more investments, and facilitating execution of one or more immigration transactions by generating one or more records for ascertaining immigration compliance of the one or more investments with respect to the one or more immigration transactions, as well as other functions described herein as functions of an immigration transaction facilitation management provider.

Investment in the PEO 1154 is used to create jobs. Job creation credits are allocated to the investment. Some embodiments track allocation of the job creation credits to jobs in the PEO 1154. In co-employment, PEO 1154 becomes the employer of record for tax purposes, filing paperwork under its own identification numbers. Several variations on the PEO model exist, differing in the nature of the relationship formed between PEO 1154 and the PEO client 1166.

Referring briefly to FIG. 2, a compliance tracking module 235 of a human resource allocation module 220, in some embodiments allocates in the accounting system one or more economic metrics to the one or more investments.

PEO 1154 provides an economic benefit 1160 that generates economic metrics 1162. As used herein, an economic benefit 1160 is defined to include any transfer resulting in improvement to economic properties of a person or an entity including but not limited to jobs, access to working capital, loans, investments, and transfer of goods or commodities. As used herein, economic metrics 1162 are quantitative indicators of economic improvement. Economic metrics 1162 include but not limited to numbers representing jobs created or saved, local unemployment rates, profitability of a business, changes in net worth of a business, or categories of employees (e.g., preferential hiring statuses (women, students, veterans, minorities). In some embodiments, jobs can include but are not limited to full time workers or opportunities, part time workers or opportunities, full time equivalent, part time equivalent, paid and unpaid internships, work study programs, mentorship programs, apprenticeship programs, full-time contractors, part-time contractors, outsourced positions, volunteer positions. As used herein, immigration approval 1164 is granting of any form of legal immigration status upon the foreign investor or investors including but not limited to visas (investor, visitor, and student), temporary or permanent residence permission.

A co-employment relationship 1170 is created between PEO 1154 and a PEO client 1166. Co-employment is the contractual arrangement between PEO client 1166 and PEO 1154 that allows PEO 1154 to provide a full range of services and to transfer or share many employer's liabilities, including immigration compliance. Workers become employees of two employers: PEO client 1166 retains supervision for production or delivery of service, and PEO 1154 assumes responsibility for human resources and personnel services, including immigration compliance.

Financial aspects of the relationship between PEO 1154 and a PEO client 1066 include loans 1168 and loan repayment 1172.

Dividend and/or stock repurchase 1176 is provided to investor 1150. In some embodiments, the return on investment is achieved through a combination of dividends paid over time and/or stock repurchase from the PEO.

PEO 1154 provides visa compliance records and reports 1156 to regulatory government 1158, sometimes but not exclusively in response to queries 1164. Referring briefly to FIG. 2, a compliance tracking module 235 of a human resource allocation module 220, in some embodiments facilitates execution of one or more immigration transactions by generating one or more records for ascertaining immigration compliance of the one or more investments with respect to the one or more immigration transactions. Queries are any requests for documentation, data, documents, records, evidence, access to or identification of sources of relevant information, from government 1158. Government 1158 includes but is not limited to a local, state and federal government organizations that can grant or recommend immigration approval of foreign investors for the granting of immigration credentials. Quasi-governmental organizations with regulatory or adjudicatory functions that can grant or recommend immigration approval to foreign investors for the granting of immigration credentials are also included.

Government reports visa approval(s) 1174 to investor 1150 or the representatives of investor 1150. As used herein, visa approval 1174 is granting of any form of legal immigration status upon the foreign investor or investors including but not limited to visas (investor, visitor, and student), temporary or permanent residence permission.

FIG. 11B is a flowchart of operations that can be performed in execution of a business model that may be implemented using a system for immigration transaction facilitation and monitoring, according to some embodiments. An investment in a PEO is recorded in an accounting system (block 1100). Jobs are created through a co-employment relationship with a PEO client supported by a debt transaction (block 1102). One or more jobs created by the one or more investments are allocated to the one or more investments by the accounting system (block 1104). Execution of one or more immigration transactions resulting in visa approval is facilitated by generating one or more records for ascertaining immigration compliance of the one or more investments with respect to the one or more immigration transactions requiring creation of jobs through the investments (block 1106).

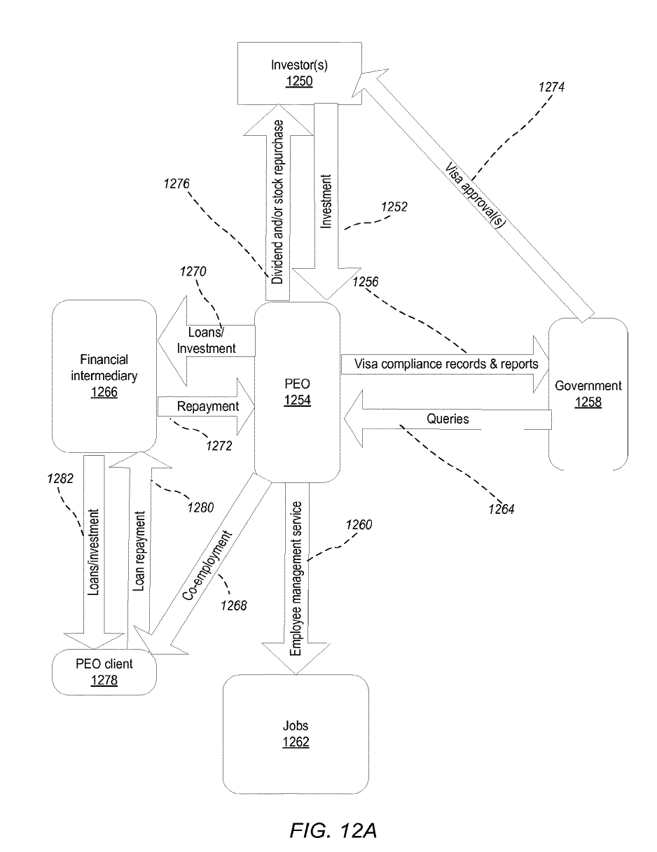

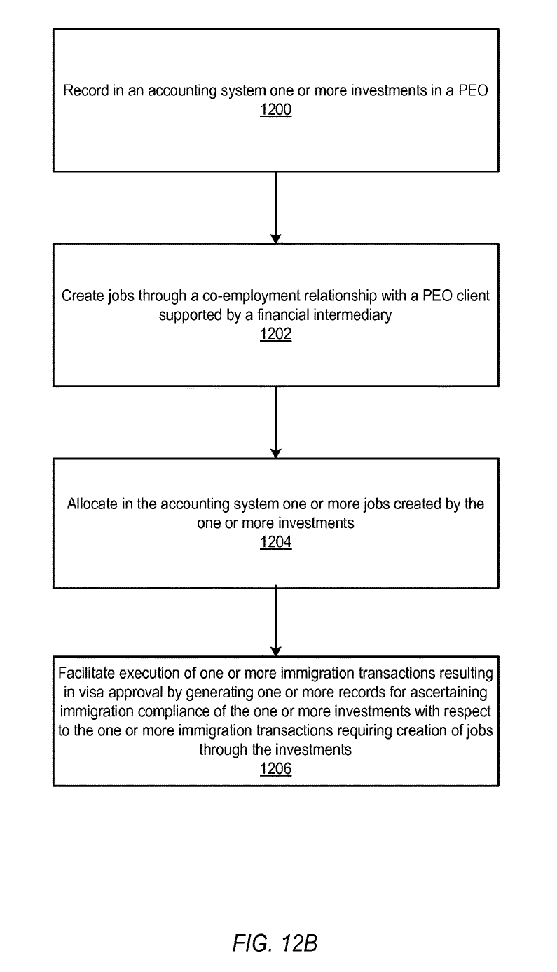

FIG. 12A illustrates a business model that may be implemented using a system for immigration transaction facilitation and monitoring, according to some embodiments. Investors 1250 provide one or more investments 1252 to a professional employer organization (PEO) 1254. As used herein, investments 1252 are one or more purchases of shares in PEO 1254 in an amount intended to fulfill or satisfy immigration requirements. Referring briefly to FIG. 2, a financial transaction module 215 of a human resource allocation module 220, in some embodiments records in an accounting system one or more investments 1252 in one or more entities.

As used herein, an investor 1250 is a foreign individual or individuals seeking a visa through placement of an investment. An investor is a qualified immigrant as defined by applicable regulations promulgated by government authorities.

As used herein, a PEO (professional employer organization) 1254 is a company that provides HR-related services to clients through a business arrangement known as co-employment, is used to facilitate the immigration transaction. In some embodiments, a PEO 1254 also serves as an investment capital deployment organization, as discussed above, and performs functions including recording in an accounting system one or more investments in one or more entities, allocating in the accounting system one or more economic metrics to the one or more investments, and facilitating execution of one or more immigration transactions by generating one or more records for ascertaining immigration compliance of the one or more investments with respect to the one or more immigration transactions, as well as other functions described herein as functions of an immigration transaction facilitation management provider.

Investment in the PEO 1254 is used to create jobs 1262. Job creation credits are allocated to the investment. Some embodiments track allocation of the job creation credits to jobs in the PEO 1254. In co-employment 1268, PEO 1254 becomes the employer of record for tax purposes, filing paperwork under its own identification numbers. Several variations on the PEO model exist, differing in the nature of the relationship formed between PEO 1254 and the PEO client 1278. Referring briefly to FIG. 2, a compliance tracking module 235 of a human resource allocation module 220, in some embodiments allocates in the accounting system one or more economic metrics to the one or more investments.

PEO 1254 provides an employee management service 1260 that generates jobs 1262. In some embodiments, jobs can include but are not limited to full time workers or opportunities, part time workers or opportunities, full time equivalent, part time equivalent, paid and unpaid internships, work study programs, mentorship programs, apprenticeship programs, full-time contractors, part-time contractors, outsourced positions, volunteer positions. As used herein, immigration approval 1274 is granting of any form of legal immigration status upon the foreign investor or investors including but not limited to visas (investor, visitor, and student), temporary or permanent residence permission.

A co-employment relationship 1268 is created between PEO 1254 and a PEO client 1278 through the use of a financial intermediary. Co-employment is the contractual arrangement between PEO client 1278 and PEO 1254 that allows PEO 1254 to provide a full range of services and to transfer or share many employer's liabilities, including immigration compliance. Workers become employees of two employers: PEO client 1278 retains supervision for production or delivery of service, and PEO 1254 assumes responsibility for human resources and personnel services, including immigration compliance.

Financial aspects of the relationship between PEO 1254 and a PEO client 1278 include loans or investments 1270 and 1282 routed through a financial intermediary 1266 and repayment 1172 and 1280, also routed through financial intermediary 1266.

Dividend and/or stock repurchase 1276 is provided to investor 1250. In some embodiments, the return on investment is achieved through a combination of dividends paid over time and/or stock repurchase from the PEO.

PEO 1254 provides visa compliance records and reports 1256 to regulatory government 1258, sometimes but not exclusively in response to queries 1264. Referring briefly to FIG. 2, a compliance tracking module 235 of a human resource allocation module 220, in some embodiments facilitates execution of one or more immigration transactions by generating one or more records for ascertaining immigration compliance of the one or more investments with respect to the one or more immigration transactions. Queries are any requests for documentation, data, documents, records, evidence, access to or identification of sources of relevant information, from government 1258. Government 1258 includes but is not limited to a local, state and federal government organizations that can grant or recommend immigration approval of foreign investors for the granting of immigration credentials. Quasi-governmental organizations with regulatory or adjudicatory functions that can grant or recommend immigration approval to foreign investors for the granting of immigration credentials are also included.

Government 1258 reports visa approval(s) 1274 to investor 1250 or the representatives of investor 1250. As used herein, visa approval 1274 is granting of any form of legal immigration status upon the foreign investor or investors including but not limited to visas (investor, visitor, and student), temporary or permanent residence permission.

FIG. 12B is a flowchart of operations that can be performed in execution of a business model that may be implemented using a system for immigration transaction facilitation and monitoring, according to some embodiments. An investment in a PEO is recorded in an accounting system (block 1200). Jobs are created through a co-employment relationship with a PEO client supported by a financial intermediary (block 1202). One or more jobs created by the one or more investments are allocated to the one or more investments by the accounting system (block 1204). Execution of one or more immigration transactions resulting in visa approval is facilitated by generating one or more records for ascertaining immigration compliance of the one or more investments with respect to the one or more immigration transactions requiring creation of jobs through the investments (block 1206).

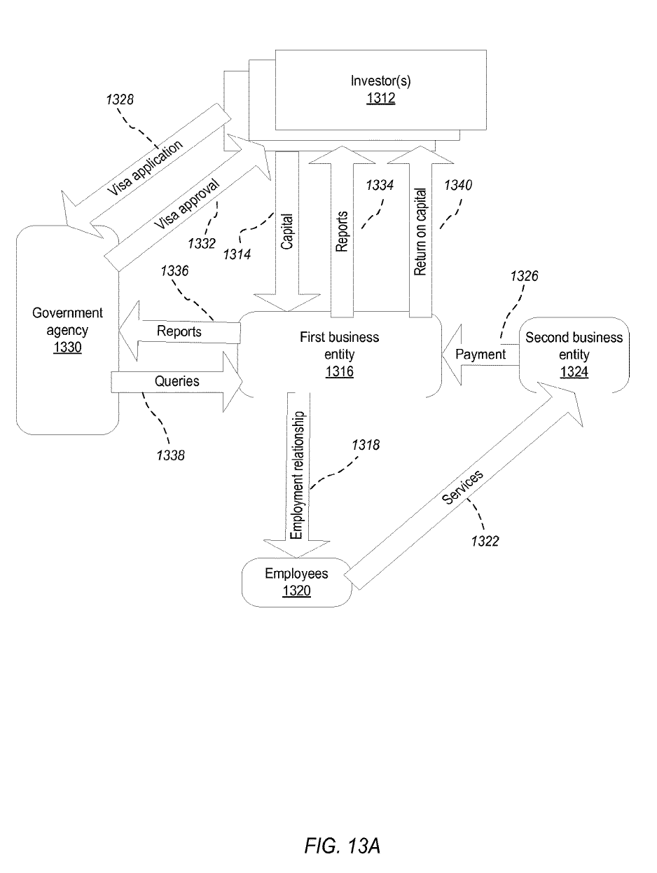

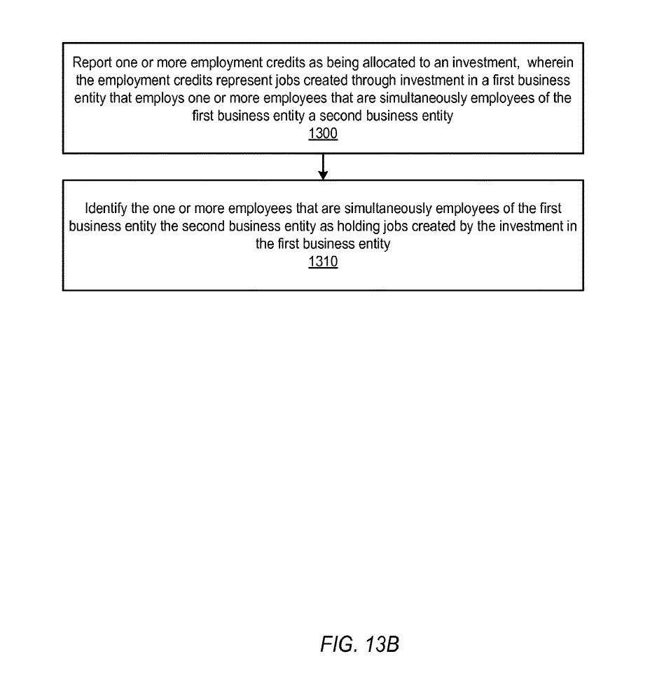

FIG. 13A illustrates a business model that may be implemented in some embodiments. One or more investors 1312 contribute capital 1314 as investments in a first business entity 1316. First entity 1316 creates an employment relationship 1318 with employees 1320, who provide services 1322 to a second business entity 1324 in exchange for payment 1326 to first business entity 1316. As a result, one or employment credits are allocated to an investment including capital 1314. An investor 1312 submits a visa application 1328 to a government agency 1330. In some embodiments one or more employment credits are reported as being allocated to an investment in reports 1334 to investor 1312 for use in visa application 1328. Investors also receive a return on capital 1340. In other embodiments one or more employment credits are reported as being allocated to an investment in reports 1336 to government agency 1330, sometimes in response to queries 1338. In some embodiments, the employment credits represent jobs created through investment of capital 1314 in first business entity 1316 that employs one or more employees 1320 that are simultaneously employees of the first business entity 1316 a second business entity 1324. The one or more employees 1320 that are simultaneously employees of the first business entity 1316 the second business 1324 entity are identified as holding jobs created by the investment of capital 1314 in the first business entity 1316.

FIG. 13B is a flowchart of operations that can be performed in execution of a business model that may be implemented using a system for employment compliance monitoring, according to some embodiments. One or more employment credits are reported as being allocated to an investment. In some embodiments, the employment credits represent jobs created through investment in a first business entity that employs one or more employees that are simultaneously employees of the first business entity and a second business entity (block 1300). The one or more employees that are simultaneously employees of the first business entity and a second business entity are identified as holding jobs created by the investment in the first business entity (block 1310).

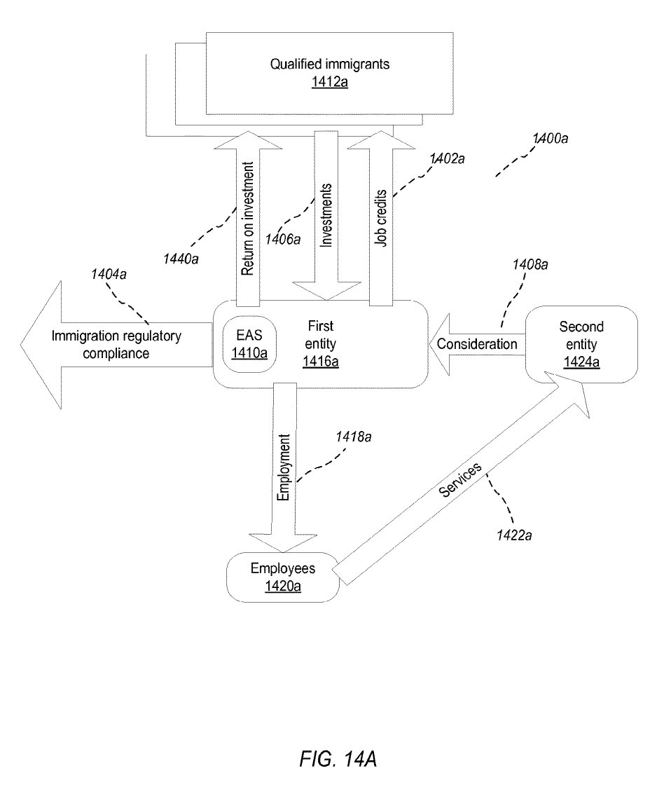

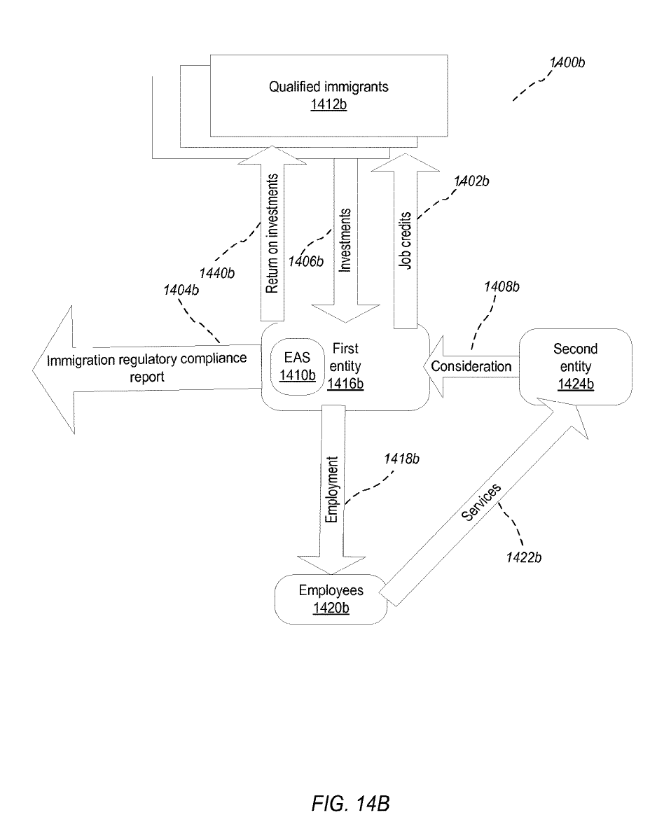

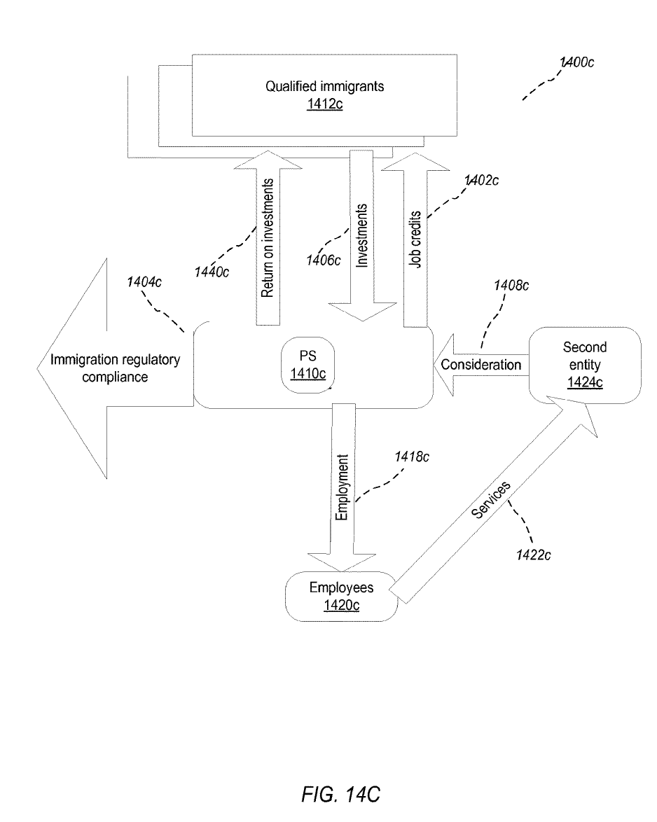

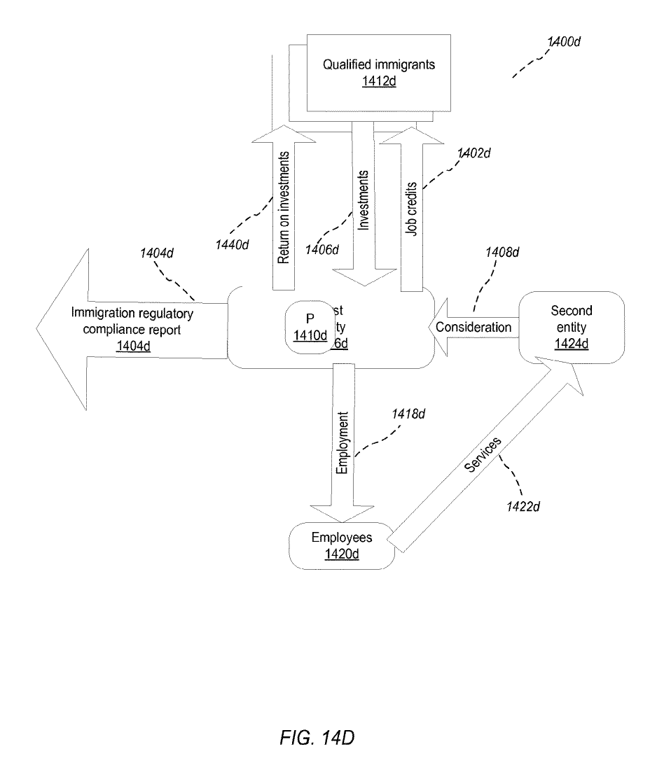

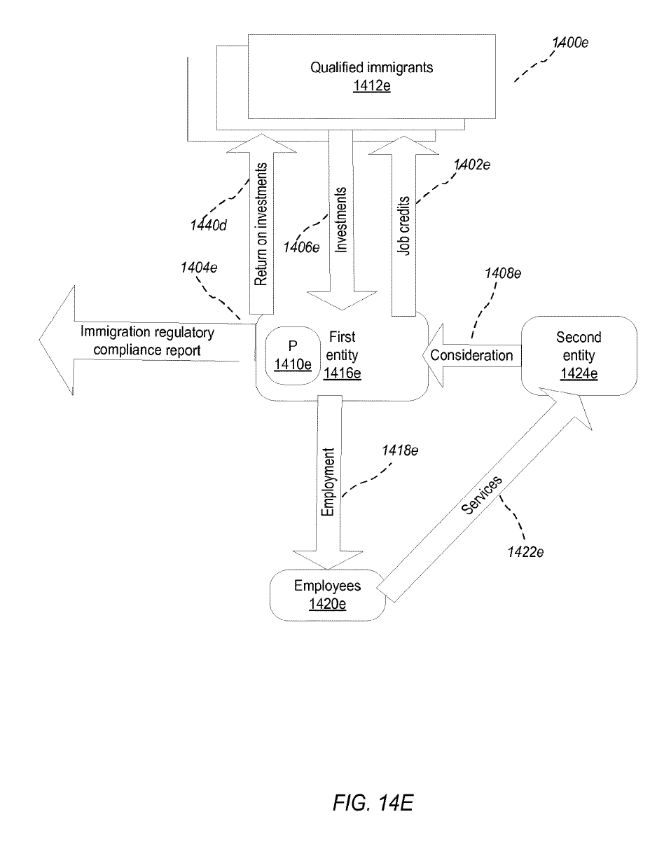

FIG. 14A illustrates a business model that may be implemented in some embodiments. Business model 1400a includes aggregating and allocating job credits 1402a for employment relationships used for immigration regulatory compliance 1404a, according to some embodiments. Investments 1406a are allowed to be provided from two or more qualified immigrants 1412a to a first entity 1416a. Investors receive a return on investment 1440a. The first entity 1416a hires two or more employees 1420a who then provide services 1422a to a second entity 1424a, and the services 1422a are provided in exchange for consideration 1408a being provided by the second entity 1424a to the first entity 1416a. Job credits 1402a for immigration regulatory compliance are aggregated in an electronic accounting system (EAS) 1410a to the first entity 1416a, based on the employment 1418a of the two or more employees 1420a. At least two of the job credits 1402a are allocated in the electronic accounting 1410a system to two or more of the qualified immigrants 1412a, for the purposes of immigration regulatory compliance 1404a of two or more of the qualified immigrants 1412a.

FIG. 14B illustrates a business model that may be implemented in some embodiments. Business model 1400b includes automatically creating at least a portion of an immigration regulatory compliance report 1404b, according to some embodiments. Investments 1406b are allowed to be provided from two or more qualified immigrants 1412b to a first entity 1416b. Investors receive a return on investment 1440b. The first entity 1416b hires two or more employees 1420b who then provide services 1422b to a second entity 1424b, and the services 1422b are provided in exchange for consideration 1408b being paid by the second entity 1424b to the first entity 1416b. Job credits 1402b for immigration regulatory compliance are received in the electronic accounting system (EAS) 1410b to the first entity 1416b, based on the employment 1418b of the two or more employees 1420b. Two or more of the job credits 1402b are applied in the electronic accounting system 1410b to two or more of the qualified immigrants 1412b, for the purposes of immigration regulatory compliance of two or more of the qualified immigrants 1412b. The applied job credits 1402b are used to automatically create at least a portion of an immigration regulatory compliance report 1404b.

FIG. 14C illustrates a business model that may be implemented in some embodiments. Business model 1400c can be performed in aggregating and allocating job credits 1402 used for immigration regulatory compliance 1404c, according to some embodiments. Investments 1406c are allowed to be provided from two or more qualified immigrants 1412c to a first entity 1416c. Investors receive a return on investment 1440c. The first entity hires two or more employees 1420c who then provide services 1422c to a second entity 1424c, and the services 1422c are provided in exchange for consideration 1408c being paid by the second entity 1424c to the first entity 1416c. Job credits 1402c for immigration regulatory compliance 1404c are aggregated in a processor system (PS) 1410c to the first entity 1416c, based on the employment 1418c of the two or more employees 1420c. At least two of the job credits 1402c are allocated in the processor system 1410c to two or more of the qualified immigrants 1412c, for the purposes of immigration regulatory compliance 1404c of two or more of the qualified immigrants 1412c.

FIG. 14D illustrates a business model that may be implemented in some embodiments. Business model 1400d includes operations that can be performed in automatically creating at least a portion of an immigration regulatory compliance report 1404d, according to some embodiments. Investments 1406d are allowed to be provided from two or more qualified immigrants 1412d to a first entity 1416d. Investors receive a return on investment 1440d. The first entity 1416d hires two or more employees 1420d who then provide services 1422d to a second entity 1424d, and the services 1422d are provided in exchange for consideration 1408d being paid by the second entity 1424d to the first entity 1416d. Job credits 1402d for immigration regulatory compliance are received in a processor (P) 1410d to the first entity 1410d, based on the employment 1418d of the two or more employees 1420d. Two or more of the job credits 1402d are applied in the processor 1410d to two or more of the qualified immigrants 1412d, for the purposes of immigration regulatory compliance of two or more of the qualified immigrants 1412d. The applied job credits 1402d are used to automatically create at least a portion of an immigration regulatory compliance report 1404d.

FIG. 14E illustrates a business model that may be implemented in some embodiments. Business model 1400e includes operations that can be performed in aggregating and allocating job credits 1402e used for immigration regulatory compliance, according to some embodiments. Investments 1406e are allowed to be provided from two or more qualified immigrants 1412e to a first entity 1416e. Investors receive a return on investment 1440e. The first entity 1416e hires two or more employees 1420e who then provide services 1422e to a second entity 1424e, and the services 1422e are provided in exchange for consideration 1408e being paid by the second entity 1424e to the first entity 1416e. Job credits 1402e for immigration regulatory compliance are received in a processor (P) 1410e to the first entity 1416e, based on the employment 1418e of the two or more employees 1420e. Two or more of the job credits are 1402e applied in the processor 1410e to two or more of the qualified immigrants 1412e, for the purposes of immigration regulatory compliance 1404e of two or more of the qualified immigrants 1412e. The applied job credits 1402e are used to automatically create at least a portion of an immigration regulatory compliance report 1404e.

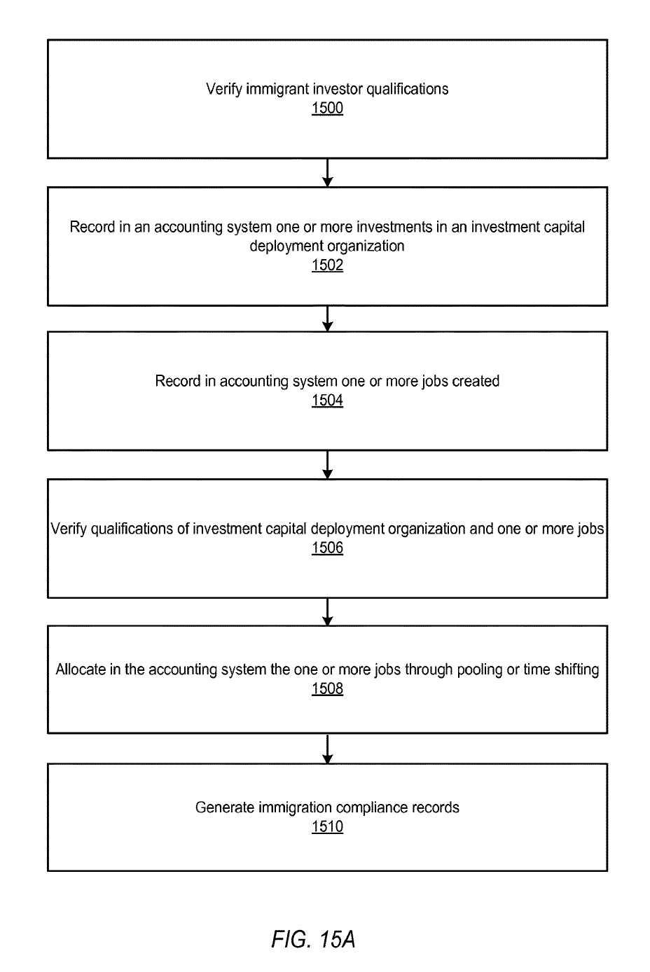

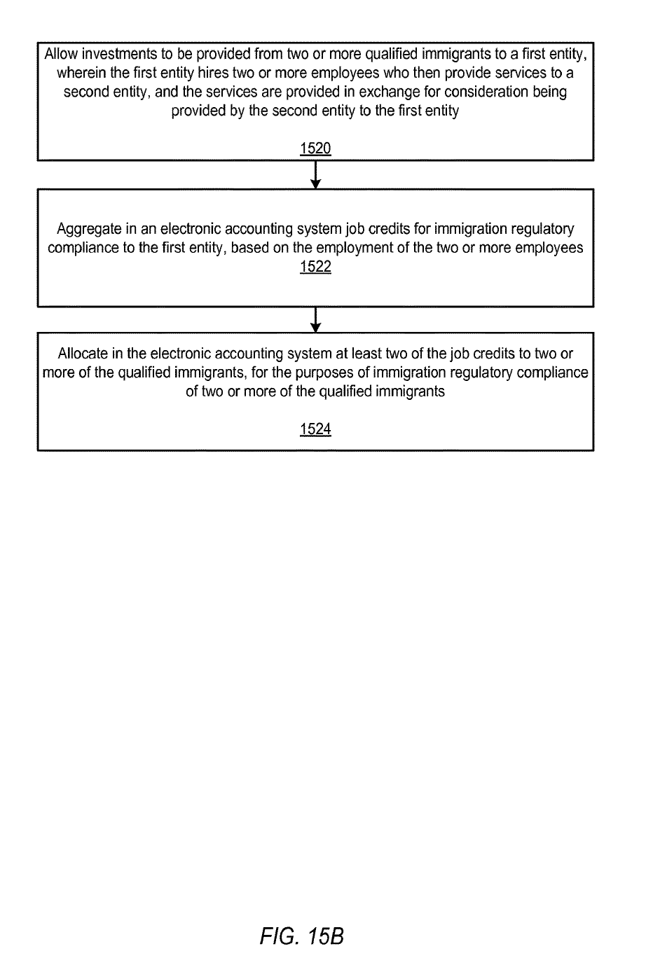

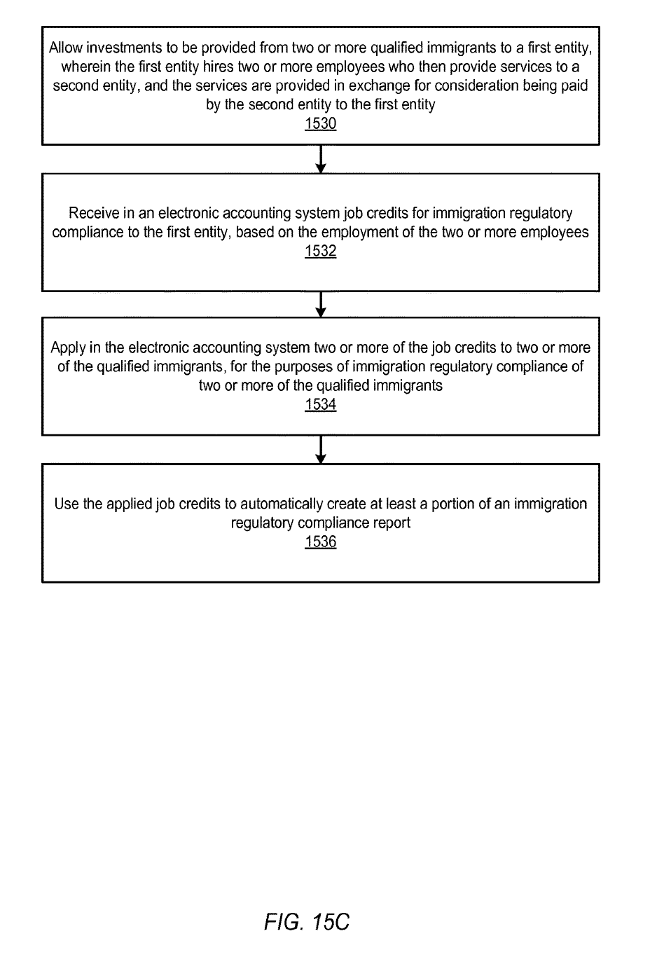

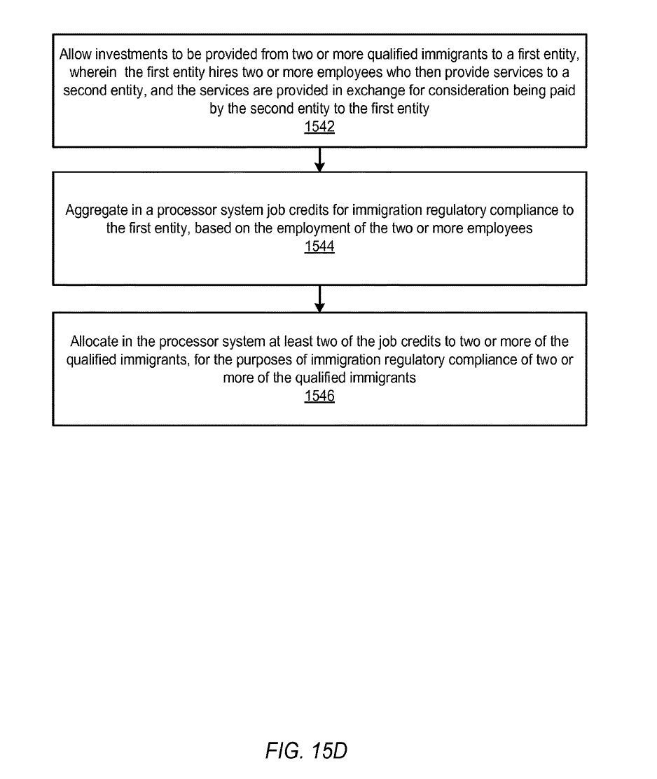

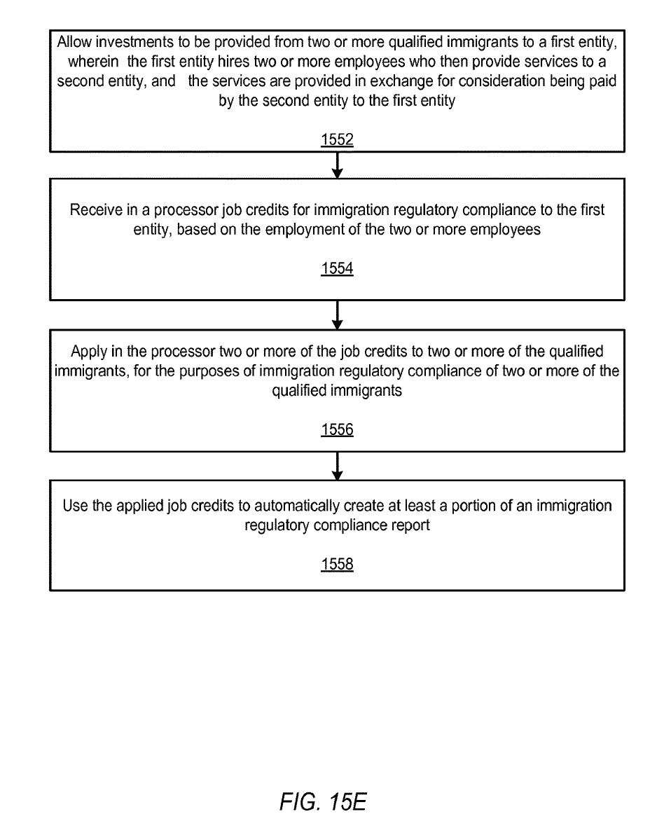

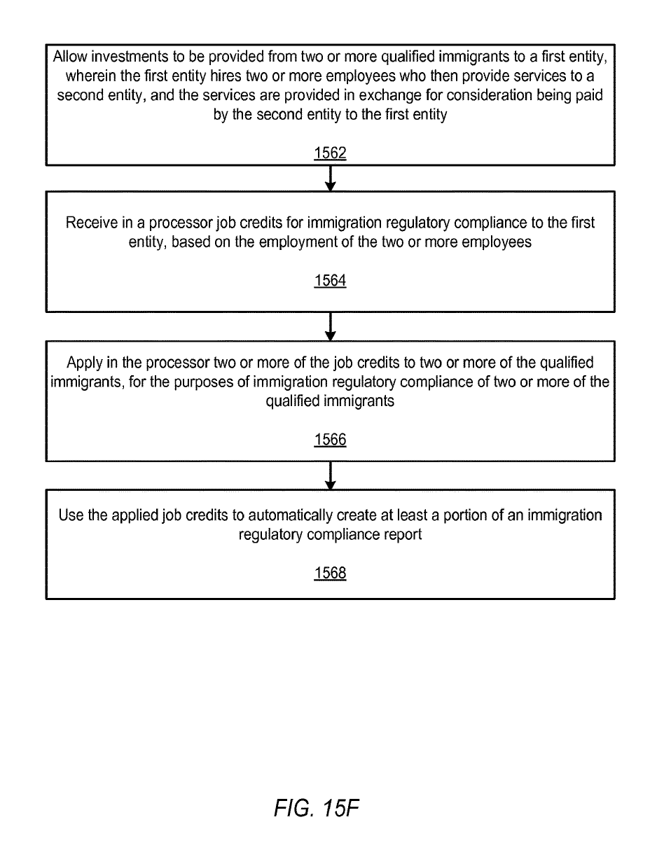

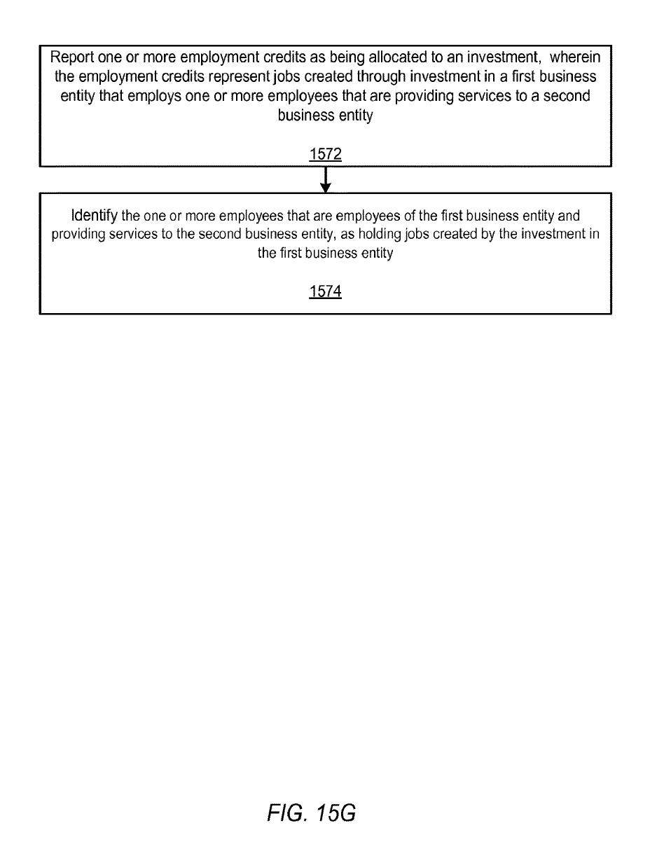

FIG. 15A is a flowchart of operations that can be performed in execution of a business model that may be implemented using a system for employment compliance monitoring, according to some embodiments. Immigrant investor qualifications are verified (block 1500). In some embodiments, verification of qualifications includes verifying that the investment funds were obtained through lawful means. Some embodiments support verifications reflecting the U.S. government policy of preventing drug money, etc. from entering the United States. Thus, such embodiments provide solutions for verifying or storage for evidence that an investor obtained the $1,000,000 for investment through lawful means. This evidence may include: bank statements; business records; tax returns; and criminal history background checks.

In some embodiments, qualifications include that the investor be actively involved in the management of the new commercial enterprise to qualify for a visa. Some embodiments support verification and documentation that the involvement consists of day-to-day management or managing the new commercial enterprise through policy formulation, which allows the investor to have more than a passive role, but an active role in the day-to-day management of the company through policy. In some embodiments, support is provided for this requirement to be satisfied in three ways (a) a true management position within the company; (b) evidence that the investor is a corporate officer or on the board of directors, and (c) evidence that the investor is directly involved in activities or policy making.

In some embodiments, evidence that the investor is a true manager of the company is stored as the investor is allowed to submit, for transmission records supporting his Form I-526 (initial) application, a comprehensive job description for the position occupied by the investor, including his job title. The job title and duties may be typical of a company President, Vice President or other similar executive management position. In some embodiments, evidence that the investor is a true manager of the company is stored as evidence for his/her initial petition that he/she is a corporate officer of the company or on the board of directors. This evidence may include the minutes from the board of directors meeting, corporate organizational charts, etc.

Another acceptable arrangement is the petitioner being involved in the direct management of activities or policy making activities of the company. The regulations suggest that forming a limited partnership may be enough to satisfy the requirement of being actively engaged in a commercial enterprise. A limited partnership is the common arrangement when funds are invested in a Regional Investment Center. The Regional Investment Center forms a limited partnership to pool capital contributions from investors in order to make an equity investment in a variety of commercial projects, such as commercial redevelopments, dairy farms, ski resorts, etc. Stephanie Lee, EB-5 Regional Investment Center Designation as Alternative to Traditional Bank Financing: Win-Win Strategy, available at: http://eb5info.com/articles/48-eb-5-regional-center-designation-as-a-viab-le-alt. And embodiments support documentation of such involvement. In such arrangements the General Partner would be responsible for the day-to-day management of the commercial enterprise and the limited partner would be accorded the rights, powers, and duties normally granted to limited partners under the Uniform Limited Partnership Act (ULPA). “Pursuant to the ULPA, these rights, powers, and duties include consulting with and advising the general partner, attending meetings of partners, and voting on dissolution, extraordinary indebtedness or change in the nature of the business partnership.” See H. Ronald Klasko, Pooled investment Arrangements: Unraveling the Controversy. Some embodiments support documentation for one or more of these activities.

One or more investments in an investment capital deployment organization are recorded in an accounting system (block 1502). In some embodiments, the investment capital deployment organization is a professional employer organization (“PEO”), which administers payroll and benefits, and performs a variety of other human resources functions for employers for a monthly fee. Once an employer signs up to use the PEO's services, the PEO assumes responsibility for issuing pay checks to employees, from funds provided by the employer. In some embodiments, the investment capital deployment organization uses the EB-5 program as a source of capital, by attracting investors to invest in their company. In some embodiments, the investments must total $1M. In other embodiments, the investments must total $0.5M.

An investor invests $1,000,000 investment capital deployment organization or is actively involved in the process of investing. If a regional investment center is used, $500,000 invested with RIC will suffice, as will $500,000 if investment is made in an area experiencing high unemployment or a rural area designated as a Targeted Employment area. See M. Keil Hackley, EB-5 Regional Center Designation as a Viable Alternative to Traditional Bank Financing: Win-Win Strategy. Regional Investment Centers will be discussed in greater detail below. “Invest” means to contribute capital to the enterprise. See EB-5 Immigrant Investors, pg. 3, 2000-01 Annual Handbook-Basics. “Capital” is defined as cash and cash equivalents, equipment, inventory, and other tangible property. See EB-5 Immigrant Investors, pg. 3, 2000-01 Annual Handbook-Basics. Typically, bank statements, escrow instructions, wire transfer receipts, and other related items are submitted as evidence to satisfy this requirement. One of skill in the art will also note that the $1,000,000 can be used to directly fund expenses, as opposed to a lump sum investment of $1,000,000. In some embodiments, investment capital deployment organization accepts multiple investments of $1,000,000. In some embodiments, investment capital deployment organization accepts simple investments of $1,000,000 in exchange for a moderate return on the investment, or something similar.

In some embodiments, the investment capital deployment organization is a new “for profit” commercial enterprise, by virtue of having been created after 1990. EB-5 regulations require that the investment be made in a qualified commercial enterprise. In some embodiments, a new commercial enterprise can be established in one of three ways: (a) creating/investing in an original business; (b) expanding an existing business; (c) or purchasing and restructuring an existing business. See EB-5 Immigrant Investors, pg. 3, 2000-01 Annual Handbook-Basics. Some embodiments store evidence of organizational documents of the investment capital deployment organization, such as the Business license; Articles of incorporation; Merger documents; and/or Partnership agreements.

In some embodiments, an investor can restructure or reorganize an existing business to create a new commercial enterprise. Embodiments support the restructuring of an existing business along the guidelines presented in Matter of AAO, Jul. 11, 2011.

One or more jobs created are recorded in an accounting system (block 1504). Some embodiments provide support for recording evidence related to the requirement that ten jobs have been created. The regulations define an employee as an individual who (1) provides services or labor for the new commercial enterprise and (2) receives wages or other remuneration directly from the new commercial enterprise. See 8 CFR s. 204.6(e)(definition of “employee”). The jobs are created for U.S. Citizens, lawful permanent residents, or other immigrants lawfully authorized to be employed in the U.S. See INA s. 203(b)(5)(A)(iii) and 8 USC s. 1153(b)(5)(A)(iii). The investor, spouse, and children also don't count toward the 10 employee minimum. Independent contractor positions are excluded from the definition. The employment is in a position that requires at least 35 hours of service per week.

In some embodiments, documentation of jobs is used in two parts of the EB-5 process: in the initial EB-5 application, the Form I-526; and after the conditional residence period when the investor seeks to remove conditions by filing a Form I-826. Embodiments provide documentation as discussed below with respect to block 1510. During the initial EB-5 application procedure in the individual investor context, the regulations recommend submitting a business plan along with the other evidence, to demonstrate how exactly the jobs will be created. Some embodiments support or provide storage and processing of such documentation and evidence. After the conditional residence period, the investor will show that 10 jobs have been created by filing employees' W-2s, Form I-9s, payroll records, and other relevant documents. Some embodiments support or provide storage and processing of such documentation and evidence.

Qualifications of the investment capital deployment organization and jobs are verified (block 1506). For example, in some embodiments, verification is performed with respect to assessing whether the investor/petitioner is actively involved in the management of the new commercial enterprise. In some embodiments, an investment can qualify if the investor expands an existing business. In order to satisfy the requirements, however, the system creates records to show that the investment resulted in an increase of at least 40 percent in the net worth of the business or a net increase in 40 percent of the number of employees of the business as described at 8 CFR s. 204.6(h)(3). In some embodiments, because the number of employees must increase by 40 percent, this could require the employer to create more than 10 new jobs in order to qualify. If the business is a large business, the burden will be higher for the individual investor. Where the 40% increase criterion is used, increases in employment are tracked to individual investors.

In some embodiments, documentation with respect to indirect job creation is supported EB-5 regulations permit direct and indirect job creation. Indirect jobs are those jobs that are created outside of the newly established commercial enterprise. For example, these jobs may include jobs involved in getting materials, equipment, and services to the commercial enterprise. The investment doesn't have to exactly lead to the jobs created. See Stephen Yale-Loehr, EB-5 Immigrant Investors, Immigration Options for Investors and Entrepreneurs. And some embodiments support verification of job qualifications through storage and processing of relevant evidence.

In embodiments supporting documentation for indirect job creation, investment may be made through a Regional Investment Center, not to an existing company under the individual investor program. Direct jobs are those that establish an employer-employee relationship between the newly created enterprise and the persons they employ. In other words, direct jobs are U.S. employees who are employed by the sponsoring company and collect a salary which is reported as income on a W2 form to the Internal Revenue Service. EB-5 regulations define an “employee” as one (1) provides services or labor for the new commercial enterprise and (2) who receives wages “directly from the new commercial enterprise.” 8 CFR s. 204.6(e).

The one or more jobs are allocated in the accounting system to the one or more investments through pooling or time shifting (block 1508). In some embodiments, investors must qualify for a visa by making investments that are credited as having created (or, in some embodiments, will create) ten full-time positions. In some embodiments, pursuant to the regulations at 8 CR s. 204.6(g), the investment capital deployment organization may pool investments from individual investors seeking permanent investor visas. Provided that all investors invest $1,000,000 each, the applicable statutory amount, newly-created jobs are then allocated by some embodiments among the pool of investors, who are seeking permanent investor visas. See also. 8 CFR s. 204.6(e); H. Ronald Klasko, Pooled investment Arrangements: Unraveling the Controversy. In some embodiments, a Regional Investment Center forms a limited partnership to pool capital contributions from investors in order to make an equity investment in a variety of commercial projects, such as commercial redevelopments, dairy farms, ski resorts, etc. Stephanie Lee, EB-5 Regional Investment Center Designation as Alternative to Traditional Bank Financing: Win-Win Strategy, available at: http://eb5info.com/articles/48-eb-5-regional-center-designation-as-a-viab-le-alt.

In some embodiments, support is provided for a regional investment center. Under the EB-5 Pilot Program, an individual can invest $500,000 in a Regional Investment Center, which is a government designated commercial enterprise. “An RIC is any economic unit, public or private, engaged in the promotion of economic growth, improved regional productivity, job creation, and increased domestic capital investment.” See M. Keil Hackley, EB-5 Regional Center Designation as a Viable Alternative to Traditional Bank Financing: Win-Win Strategy; 8 CFR s. 206.6(e)(ii). Regional Investment Centers usually outline a particular project for which investments are sought, which must be pre-approved by USCIS. This certification process can be lengthy, both to prepare and then to approve by USCIS, and some embodiments provide support for accumulating, storing and processing evidence and documentation used in the verification process. Once the Regional Investment Center application is approved, individuals can apply for an EB-5 visa through the Regional Investment Center. Their investments will go to fund the project approved by USCIS.

Immigration compliance records are generated (block 1510). Records resulting from some embodiments are used in preparing an 1-526 petition or an 1-829 petition. In some embodiments, the investor or the immigration transaction facilitation management provider 106 acting on his behalf will initially file an I-526 petition, which will demonstrate, through a business plan or other documentary evidence, which is sometimes stored within media supported by immigration transaction facilitation management provider 106, how the jobs are to be created. If the Form I-526 petition is approved, the investor will become a conditional resident for two years. In some embodiments, the investor or the immigration transaction facilitation management provider 106 acting on his behalf will (e.g., at the end of the two year period) submit another application with Form I-829, Petition by Entrepreneur to Remove Conditions, to USCIS which shows that ten full-time jobs were created.

In some embodiments, the investor or the immigration transaction facilitation management provider 106 acting on his behalf will submit along with the Form I-829, in order to show that ten full-time jobs were created within the conditional two-year period:
The number of full time employees at the time of investment and at the time of the Form I-829 filing i.e., business payroll records, relevant tax documents, and employee W-2 and I-9 forms;
That the jobs created were for qualifying employment, i.e. U.S. citizens, lawful permanent residents, or other work-authorized immigrants, excluding investor and immediate family; and
That the jobs created are full-time, i.e. at least 35 hours per week.

For details of this documentation, see Elsie Hui Arias, Practical Guidance in Preparing I-526 and I-829 Petitions, Immigration Options for Investing and Entrepreneurs.

In some embodiments, timing of documentation is tracked by immigration transaction facilitation management provider 106 using human resource allocation module 120. For example, the two year conditional lawful permanent resident status period begins when the investor first enters the United States in reliance upon an immigrant visa or is first adjudicated in this status. Essentially, the two year conditional residence period begins upon approval of I-526 petition. The investor or transaction facilitation management provider 106 acting on his behalf files a petition seeking to remove conditions 90 days before the second anniversary of the conditional residence period.

FIG. 15B is a flowchart of operations that can be performed in aggregating and allocating job credits used for immigration regulatory compliance, according to some embodiments. Investments are allowed to be provided from two or more qualified immigrants to a first entity. The first entity hires two or more employees who then provide services to a second entity, and the services are provided in exchange for consideration being provided by the second entity to the first entity (block 1520). Job credits for immigration regulatory compliance are aggregated in an electronic accounting system to the first entity, based on the employment of the two or more employees (block 1522). At least two of the job credits are allocated in the electronic accounting system to two or more of the qualified immigrants, for the purposes of immigration regulatory compliance of two or more of the qualified immigrants (block 1524).

FIG. 15C is a flowchart of operations that can be performed in automatically creating at least a portion of an immigration regulatory compliance report, according to some embodiments. Investments are allowed to be provided from two or more qualified immigrants to a first entity. The first entity hires two or more employees who then provide services to a second entity, and the services are provided in exchange for consideration being paid by the second entity to the first entity (block 1530). Job credits for immigration regulatory compliance are received in the electronic accounting system to the first entity, based on the employment of the two or more employees (block 1532). Two or more of the job credits are applied in the electronic accounting system to two or more of the qualified immigrants, for the purposes of immigration regulatory compliance of two or more of the qualified immigrants (block 1534). The applied job credits are used to automatically create at least a portion of an immigration regulatory compliance report (block 1536).

FIG. 15D is a flowchart of operations that can be performed in aggregating and allocating job credits used for immigration regulatory compliance, according to some embodiments. Investments are allowed to be provided from two or more qualified immigrants to a first entity. The first entity hires two or more employees who then provide services to a second entity, and the services are provided in exchange for consideration being paid by the second entity to the first entity (block 1542). Job credits for immigration regulatory compliance are aggregated in a processor system to the first entity, based on the employment of the two or more employees (block 1544). At least two of the job credits are allocated in the processor system to two or more of the qualified immigrants, for the purposes of immigration regulatory compliance of two or more of the qualified immigrants (block 1546).

FIG. 15E is a flowchart of operations that can be performed in automatically creating at least a portion of an immigration regulatory compliance report, according to some embodiments. Investments are allowed to be provided from two or more qualified immigrants to a first entity. The first entity hires two or more employees who then provide services to a second entity, and the services are provided in exchange for consideration being paid by the second entity to the first entity (block 1552). Job credits for immigration regulatory compliance are received in a processor to the first entity, based on the employment of the two or more employees (block 1554). Two or more of the job credits are applied in the processor to two or more of the qualified immigrants, for the purposes of immigration regulatory compliance of two or more of the qualified immigrants (block 1556). The applied job credits are used to automatically create at least a portion of an immigration regulatory compliance report (block 1558).

FIG. 15F is a flowchart of operations that can be performed in aggregating and allocating job credits used for immigration regulatory compliance, according to some embodiments. Investments are allowed to be provided from two or more qualified immigrants to a first entity. The first entity hires two or more employees who then provide services to a second entity, and the services are provided in exchange for consideration being paid by the second entity to the first entity (block 1562). Job credits for immigration regulatory compliance are received in a processor to the first entity, based on the employment of the two or more employees (block 1564). Two or more of the job credits are applied in the processor to two or more of the qualified immigrants, for the purposes of immigration regulatory compliance of two or more of the qualified immigrants (block 1566). The applied job credits are used to automatically create at least a portion of an immigration regulatory compliance report (block 1568).

FIG. 15G is a flowchart of operations that can be performed in execution of a business model that may be implemented using a system for employment compliance monitoring, according to some embodiments. One or more employment credits as being allocated to an investment. The employment credits represent jobs created through investment in a first business entity that employs one or more employees that are providing services to a second business entity (block 1572). The one or more employees that are employees of the first business entity and providing services to the second business entity, are identified as holding jobs created by the investment in the first business entity (block 1574).

### Example System

Embodiments of a human resource allocation module and/or of the various immigration transaction facilitation and monitoring techniques as described herein may be executed on one or more computer systems, which may interact with various other devices. One such computer system is illustrated by FIG. 16. In different embodiments, computer system 1600 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1600 includes one or more processors 1610 coupled to a system memory 1620 via an input/output (I/O) interface 1630. Computer system 1600 further includes a network interface 1640 coupled to I/O interface 1630, and one or more input/output devices 1650, such as cursor control device 1660, keyboard 1670, and display(s) 1680. In some embodiments, it is contemplated that embodiments may be implemented using a single instance of computer system 1600, while in other embodiments multiple such systems, or multiple nodes making up computer system 1600, may be configured to host different portions or instances of embodiments. For example, in one embodiment some elements may be implemented via one or more nodes of computer system 1600 that are distinct from those nodes implementing other elements.

In various embodiments, computer system 1600 may be a uniprocessor system including one processor 1610, or a multiprocessor system including several processors 1610 (e.g., two, four, eight, or another suitable number). Processors 1610 may be any suitable processor capable of executing instructions. For example, in various embodiments, processors 1610 may be general-purpose or embedded processors implementing any of a variety of instruction set architectures (ISAs), such as the x86, PowerPC, SPARC, or MIPS ISAs, or any other suitable ISA. In multiprocessor systems, each of processors 1610 may commonly, but not necessarily, implement the same ISA.

In some embodiments, at least one processor 1610 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the image processing methods disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1620 may be configured to store program instructions and/or data accessible by processor 1610. In various embodiments, system memory 1620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a human resource allocation module are shown stored within system memory 1620 as program instructions 1625 and data storage 1635, respectively. In other embodiments, program instructions and/or data may be received, sent or stored upon different types of computer-accessible media or on similar media separate from system memory 1620 or computer system 1600. Generally speaking, a computer-accessible medium may include storage media or memory media such as magnetic or optical media, e.g., disk or CD/DVD-ROM coupled to computer system 1600 via I/O interface 1630. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1640.

In one embodiment, I/O interface 1630 may be configured to coordinate I/O traffic between processor 1610, system memory 1620, and any peripheral devices in the device, including network interface 1640 or other peripheral interfaces, such as input/output devices 1650. In some embodiments, I/O interface 1630 may perform any necessary protocol, timing or other data transformations to convert data signals from one component (e.g., system memory 1620) into a format suitable for use by another component (e.g., processor 1610). In some embodiments, I/O interface 1630 may include support for devices attached through various types of peripheral buses, such as a variant of the Peripheral Component Interconnect (PCI) bus standard or the Universal Serial Bus (USB) standard, for example. In some embodiments, the function of I/O interface 1630 may be split into two or more separate components, such as a north bridge and a south bridge, for example. In addition, in some embodiments some or all of the functionality of I/O interface 1630, such as an interface to system memory 1620, may be incorporated directly into processor 1610.

Network interface 1640 may be configured to allow data to be exchanged between computer system 1600 and other devices attached to a network, such as other computer systems, or between nodes of computer system 1600. In various embodiments, network interface 1640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1650 may, in some embodiments, include one or more display terminals, keyboards, keypads, touchpads, scanning devices, voice or optical recognition devices, or any other devices suitable for entering or retrieving data by one or more computer system 1600. Multiple input/output devices 1650 may be present in computer system 1600 or may be distributed on various nodes of computer system 1600. In some embodiments, similar input/output devices may be separate from computer system 1600 and may interact with one or more nodes of computer system 1600 through a wired or wireless connection, such as over network interface 1640.

As shown in FIG. 16, memory 1620 may include program instructions 1625, configured to implement embodiments of a human resource allocation module as described herein, and data storage 1635, comprising various data accessible by program instructions 1625. In one embodiment, program instructions 1625 may include software elements of embodiments of a human resource allocation module as illustrated in the above Figures. Data storage 1635 may include data that may be used in embodiments. In other embodiments, other or different software elements and data may be included.

Those skilled in the art will appreciate that computer system 1600 is merely illustrative and is not intended to limit the scope of a human resource allocation module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1600 may be transmitted to computer system 1600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A method for automatically creating at least a portion of an immigration regulatory compliance report, comprising:
receiving, via a network interface over an Internet connection, investment data indicating investments provided from two or more qualified immigrants to a first entity, wherein the first entity is a professional employer organization, the first entity hires two or more employees who then provide services to a second entity utilizing a co-employment arrangement between the first entity and the second entity with respect to services of the two or more employees wherein the first entity and the second entity share employment responsibilities for the two or more employees, wherein the first entity and second entity are co-employers of the two or more employees, wherein the employment responsibilities of the first entity under the co-employment arrangement include immigration compliance reporting, and wherein the second entity supervises delivery of the services by the two or more employees as a portion of the employment responsibilities under the co-employment arrangement; and the services are provided in exchange for consideration being paid by the second entity to the first entity;
receiving jobs credit data, via the network interface over the Internet connection, in an electronic accounting system that includes a processor and a memory, the jobs credit data indicating immigration regulatory compliance job credits usable by the first entity, based on the employment of the two or more employees by the first entity to provide the services to the second entity;
automatically applying in the electronic accounting system via operational steps performed by the processor, two or more of the immigration regulatory compliance job credits in accordance with the job credits data to the two or more of the qualified immigrants by:
determining an amount of time remaining for each of the two or more of the qualified immigrants to comply with an immigration regulatory requirement; and
generating allocated job credits data by automatically allocating the immigration regulatory compliance job credits in accordance with the job credits data among the two or more of the qualified immigrants so that the immigration regulatory compliance job credits are allocated first to one of the two or more of the qualified immigrants having a least amount of the time remaining to comply with an immigration regulatory requirement;
using the allocated job credits data to automatically create, via the operational steps performed by the processor, at least a portion of an immigration regulatory compliance report for the two or more employees pursuant to the employment responsibilities of the first entity under the co-employment arrangement;
storing in a memory associated with the processor, the immigration regulatory compliance report; and
transmitting, via the network interface over the Internet connection, the immigration regulatory compliance report.

2. The method of claim 1, further comprising automatically transmitting, via the network interface, the immigration regulatory compliance report to a regulatory agency.

3. The method of claim 1, wherein the applying is performed automatically by the electronic accounting system, after receipt of the job credits into the accounting system via the network interface.

4. The method of claim 1, further comprising automatically ensuring that the job credits for any employee are only applied as a job credit for one of the two or more qualified immigrants.

5. The method of claim 1, wherein receiving investment data indicating investments provided from two or more qualified immigrants to the first entity further comprises allowing investments to be provided from two or more qualified immigrants to the first entity without allowing investments to be provided from two or more qualified immigrants to the second entity.

6. A system for automatically creating at least a portion of an immigration regulatory compliance report, the system comprising:
a network interface that receives investment data via a network that includes an Internet connection, the investment data indicating investments provided from two or more qualified immigrants to a first entity, wherein the first entity is a professional employer organization that hires two or more employees who then provide services to a second entity utilizing a co-employment arrangement between the first entity and the second entity with respect to services of the two or more employees wherein the first entity and the second entity share employment responsibilities for the two or more employees, wherein the first entity and second entity are co-employers of the two or more employees, wherein the employment responsibilities of the first entity under the co-employment arrangement include immigration compliance reporting, and wherein the second entity supervises delivery of the services by the two or more employees as a portion of the employment responsibilities under the co-employment arrangement, and the services are provided in exchange for consideration being paid by the second entity to the first entity, and wherein the network interface further receives jobs credit data indicating immigration regulatory compliance job credits usable by the first entity, based on the employment of the two or more employees by the first entity to provide the services to the second entity;
a processor, coupled to the network interface, configured to perform operational steps including:
determining an amount of time remaining for each of the two or more of the qualified immigrants to comply with an immigration regulatory requirement; and
generating allocated job credits data by automatically allocating the immigration regulatory compliance job credits in accordance with the job credits data among the two or more of the qualified immigrants so that the immigration regulatory compliance job credits are allocated first to one of the two or more of the qualified immigrants having a least amount of the time remaining to comply with an immigration regulatory requirement; and
using the allocated job credits data to automatically create, via the operational steps performed by the processor, at least a portion of an immigration regulatory compliance report for the two or more employees pursuant to the employment responsibilities of the first entity under the co-employment arrangement; and
a memory configured to store the immigration regulatory compliance report.
